(19) United States
(12) Patent Application Publication
(10) Pub. No.: US 2024/0296151 A1
(43) Pub. Date: Sep. 5, 2024

(54) CLOUD SERVER APPLICATION MANAGEMENT METHOD, APPARATUS, DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Zhiqiang YUAN, Shenzhen (CN); Xinda ZHAO, Shenzhen (CN); Yandong YANG, Shenzhen (CN)

(21) Appl. No.: 18/660,635

(22) Filed: May 10, 2024

Related U.S. Application Data
(63) Continuation of application No. PCT/CN2023/114656, filed on Aug. 24, 2023.

(30) Foreign Application Priority Data
Sep. 26, 2022 (CN) 202211171432.X

(51) Int. Cl. G06F 16/22; H04L 67/10

(52) U.S. Cl. CPC G06F 16/2255; H04L 67/10

(57) ABSTRACT

This application provides a data processing method, apparatus, a device, a computer-readable storage medium, and a computer program product. The method includes determining, in a case that a first cloud application client obtains to-be-rendered resource data of a cloud application, a hash value of the to-be-rendered resource data; searching, based on the hash value of the to-be-rendered resource data, a global hash table corresponding to the cloud application, to obtain a hash search result; obtaining, in a case that the hash search result indicates that a global hash value identical to the hash value of the to-be-rendered resource data is found in the global hash table, a global resource address identifier to which the global hash value is mapped; and obtaining a global shared resource based on the global resource address identifier, and mapping the global shared resource to a rendering process corresponding to the cloud application, to obtain a rendered image in a case that the first cloud application client runs the cloud application, the global shared resource being a rendered resource in a case that the cloud server loads the to-be-rendered resource data for the first time to output a rendered image.

### RELATED APPLICATION

This application is a continuation of and claims priority to PCT Application No. PCT/CN2023/114656, filed Aug. 24, 2023, which claims priority to Chinese Patent Application No. 202211171432.X, filed on Sep. 26, 2022, each of which is incorporated by reference in its entirety.

### FIELD OF THE TECHNOLOGY

This application relates to the field of cloud application technologies, and in particular, to a data processing method and apparatus, a device, a computer-readable storage medium, and a computer program product.

### BACKGROUND

Currently, in a cloud application scenario, each user may establish a connection to a cloud server, to operate and run a cloud application (for example, a cloud game X) on a respective user terminal. However, when each user terminal establishes the connection to the cloud server and runs the cloud game X in the cloud server, the cloud server needs to configure a corresponding video memory space separately for each user terminal, to store a corresponding rendered resource.

For ease of understanding, herein, for example, the user includes a game user A1 and a game user A2. When a user terminal (for example, a user terminal B1) used by the game user A1 and a user terminal (for example, a user terminal B2) used by the game user A2 establish connections to the cloud server, when running the cloud game X, the cloud server needs to separately configure, in the cloud server, one video memory space for the user terminal B1 and another video memory space for the user terminal B2. This means that for a plurality of user terminals concurrently running the same cloud game, a video memory space needs to be allocated for each user terminal indiscriminately to load a game resource. When a large quantity of user terminals concurrently run the same cloud game, the cloud server may repeatedly load and compile resource data, thereby wasting a limited resource (for example, a video memory resource) in the cloud server.

### SUMMARY

Aspects of the disclosure provide a data processing method and apparatus, a device, a computer-readable storage medium, and a computer program product, to avoid repeated loading of resource data through resource sharing, thereby improving output efficiency of a rendered image.

One aspect of this disclosure provides method performed by a cloud server that includes a plurality of cloud application clients running concurrently, wherein the plurality of cloud application clients include a first cloud application client. The method includes: determining, based on the first cloud application client obtaining to-be-rendered resource data of a cloud application, a hash value of the to-be-rendered resource data; searching, based on the hash value of the to-be-rendered resource data, a global hash table corresponding to the cloud application, to obtain a hash search result; obtaining, based on the hash search result indicating that a global hash value identical to the hash value of the to-be-rendered resource data is found in the global hash table, a global resource address identifier (ID) to which the global hash value is mapped; obtaining a global shared resource based on the global resource address ID; and mapping the global shared resource to a rendering process corresponding to the cloud application, to obtain a rendered image.

One aspect of this application provides a data processing apparatus. The apparatus runs in a cloud server, the cloud server includes a plurality of cloud application clients running concurrently, and the plurality of cloud application clients include a first cloud application client. The apparatus includes:
a hash determining module, configured to determine, in a case that the first cloud application client obtains to-be-rendered resource data of a cloud application, a hash value of the to-be-rendered resource data;
a hash search module, configured to search, based on the hash value of the to-be-rendered resource data, a global hash table corresponding to the cloud application, to obtain a hash search result;
an address ID obtaining module, configured to obtain, in a case that the hash search result indicates that a global hash value identical to the hash value of the to-be-rendered resource data is found in the global hash table, a global resource address ID to which the global hash value is mapped; and
a shared resource obtaining module, configured to obtain a global shared resource based on the global resource address ID, and map the global shared resource to a rendering process corresponding to the cloud application, to obtain a rendered image in a case that the first cloud application client runs the cloud application.

An aspect of this application provides a computer device, including a memory and a processor, the memory being connected to the processor, the memory being configured to store a computer program, and the processor being configured to invoke the computer program, to cause the computer device to perform the method provided in the foregoing aspect of this application.

An aspect of this application provides a computer-readable storage medium, the computer-readable storage medium storing a computer program, and the computer program being loaded and executed by a processor, to cause a computer device having the processor to perform the method provided in the foregoing aspect of this application.

This application provides a computer program product or a computer program, the computer program product or the computer program including a computer instruction, the computer instruction being stored in a computer-readable storage medium, a processor of a computer device reading the computer instruction from the computer-readable storage medium, and the processor executing the computer instruction, to cause the computer device to execute the method provided in the foregoing aspect.

A cloud server may include a plurality of cloud application clients running concurrently, and the plurality of cloud application clients herein may include a first cloud application client. It may be understood that, the cloud server may determine, based on the first cloud application client obtaining to-be-rendered resource data of a cloud application, a hash value of the to-be-rendered resource data. The cloud server may search, based on the hash value of the to-be-rendered resource data, a global hash table corresponding to the cloud application, to obtain a hash search result. The cloud server may obtain, based on the hash search result indicating that a global hash value identical to the hash value of the to-be-rendered resource data is found in the global hash table, a global resource address ID to which the global hash value is mapped. The cloud server may further obtain a global shared resource based on the global resource address ID, and map the global shared resource to a rendering process corresponding to the cloud application, to obtain a rendered image in a case that the first cloud application client runs the cloud application. It may be understood that the global shared resource is a rendered resource in a case that the cloud server loads the to-be-rendered resource data for the first time to output a rendered image. When a cloud application client (for example, the first cloud application client) running in the cloud server needs to load resource data (that is, the to-be-rendered resource data, for example, the to-be-rendered resource data may be resource data of a to-be-rendered texture resource) of the cloud application, the global hash table may be searched based on a hash value of the to-be-rendered resource data (that is, the resource data of the to-be-rendered texture resource), to determine whether there is a global resource address ID to which the hash value is mapped. If yes, a rendered resource (that is, a global shared resource) shared in the cloud server can be quickly obtained for the first cloud application client based on the global resource address ID. In this way, repeated loading of the resource data can be avoided in the cloud server through resource sharing. In addition, it may be understood that, the cloud server may further map the obtained rendered resource to the rendering process corresponding to the cloud application, to quickly and stably generate, without separately loading and compiling the to-be-rendered resource data, a rendered image of the cloud application running in the first cloud application client, thereby improving rendering efficiency.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a diagram of an architecture of a cloud application processing system according to one or more illustrative aspects described herein.

FIG. 2 is a schematic diagram of a data exchange scenario of a cloud application according to one or more illustrative aspects described herein.

FIG. 3 is a schematic flowchart of a data processing method according to one or more illustrative aspects described herein.

FIG. 4 is a schematic diagram of a scenario of a plurality of cloud application clients running concurrently in a cloud server according to one or more illustrative aspects described herein.

FIG. 5 is a diagram of an internal architecture of a GPU driver deployed in a cloud server according to one or more illustrative aspects described herein.

FIG. 6 is a schematic diagram of a search relationship between global service data tables stored in a device according to one or more illustrative aspects described herein.

FIG. 7 shows another data processing method according to one or more illustrative aspects described herein.

FIG. 8 is a schematic flowchart of allocating a video memory space according to one or more illustrative aspects described herein.

FIG. 9 is an invocation timing diagram for describing an invocation relationship between driver programs in a GPU driver according to one or more illustrative aspects described herein.

FIG. 10 is a schematic diagram of loading to-be-rendered resource data to output a rendered image according to one or more illustrative aspects described herein.

FIG. 11 is a schematic diagram of a structure of a data processing apparatus according to one or more illustrative aspects described herein.

FIG. 12 is a schematic diagram of a structure of a computer device according to one or more illustrative aspects described herein.

### DETAILED DESCRIPTION

The following clearly describes technical solutions in aspects of this application with reference to accompanying drawings in the aspects of this application. The specific aspects described herein are merely intended to explain this application, but are not intended to limit this application.

The aspects of this application relate to cloud computing and a cloud application. The cloud computing may be a computing mode, which distributes computing tasks in a resource pool including a large quantity of computers, so that various application systems can obtain computing power, storage spaces, and information services as required. A network that provides resources is referred to as “cloud”. From the perspective of users, resources in the “cloud” can be infinitely expanded, and can be obtained at any time, used on demand, expanded at any time, and paid according to use. A basic capability provider of cloud computing establishes a cloud computing resource pool (referred to as a cloud platform for short, which is generally referred to as an infrastructure as a service (IaaS) platform), and deploys a plurality of types of virtual resources in the resource pool for external customers to choose and use. The cloud computing resource pool may include a computing device (such as a virtualized machine, including an operating system), a storage device, and/or a network device.

As a subset of cloud computing, the cloud application is an aspect of a cloud computing technology at an application layer. A working principle of the cloud application is a new type of application that improves a conventional software use manner of local installation and local computing via a real-time obtaining and use service that connects to a remote server cluster through the Internet or a local area network and controls the remote server cluster to complete a service logic or a computing task. An advantage of the cloud application is that an application program (for example, a cloud application client) of the cloud application runs at a server side (that is, a cloud server), the server side (that is, the cloud server) executes computing work of the cloud application, such as data rendering, and then transmits a computing result of the cloud application to a user client in a terminal device for display, and the user client may collect user operation information (which may also be referred to as object operation data of the cloud application, or may be referred to as input event data of the cloud application), and transmit the operation information to the cloud application client at the server side (that is, the cloud server), so that the server side (that is, the cloud server) controls the cloud application.

In one or more aspects of this application, the cloud application client is a cloud application instance running at the server side (that is, the cloud server), and the user client may refer to a client that supports installation in a terminal device and can provide a corresponding cloud application experience service for a user. In short, the user client may be configured to output a cloud application display page corresponding to the cloud application client, and may also be referred to as a cloud application user client. The cloud application may include cloud gaming, cloud education, cloud conferencing, cloud calling, cloud social, and/or the like. Cloud gaming, as a typical cloud application, has attracted increasing attention in recent years.

Cloud gaming, also referred to as gaming on demand, is an online game technology based on the cloud computing technology. With the cloud gaming technology, a thin client with limited graphics processing and data computing capabilities can run high-quality games. In a cloud gaming service scenario, a game is not in a game terminal used by a user, and only a user client runs in the game terminal. A real game application program (for example, a cloud game client) runs at a server side (that is, a cloud server). The server side (that is, the cloud server) renders a game scene in the cloud game into audio and video bitstreams, and transmits the rendered audio and video bitstreams to the user client in the game terminal, and the user client plays the received audio and video bitstreams. The game terminal does not need to have powerful graphics computing and data processing capabilities, but only needs to have a basic streaming media playing capability and capabilities to obtain user input event data and transmit the user input event data to the cloud game client. When the user experiences the cloud game, the user essentially operates the audio and video bitstreams of the cloud game. For example, input event data (or referred to as object operation data or a user operation instruction) is generated by using a touchscreen, a keyboard, a mouse, a rocker, or the like, and then is transmitted to the cloud game client at the server side (that is, the cloud server) through a network, to operate the cloud game.

In this application, the game terminal may refer to a terminal device used when a player experiences the cloud game, that is, a terminal device in which a user client corresponding to a cloud game client is installed, and the player herein may refer to a user who is experiencing the cloud game or requesting to experience the cloud game. The audio and video bitstreams may include an audio stream and a video stream that are generated by the cloud game client, the audio stream may include continuous audio data generated by the cloud game client during operation, and the video stream may include image data (for example, a game picture) that has been rendered during operation of the cloud game. It is to be understood that in the aspects of this application, the image data (for example, the game picture) that has been rendered may be collectively referred to as a rendered image. For example, the video stream may be considered as a video sequence including a series of image data (for example, game pictures) that has been rendered by the cloud server. In this case, the rendered image may also be considered as a video frame in the video stream.

The operation of the cloud application (for example, the cloud game) involves a communication connection between the cloud application client at the server side (that is, the cloud server) and the terminal device (for example, the game terminal) (which may be a communication connection between the cloud application client and the user client in the terminal device). After the communication connection is successfully established between the cloud application client and the terminal device, a cloud application data stream in the cloud application may be transmitted between the cloud application client and the terminal device. For example, the cloud application data stream may include a video stream (including a series of image data generated by the cloud application client during operation of the cloud game) and an audio stream (including audio data generated by the cloud application client during operation of the cloud game, where for case of understanding, the audio data herein and the image data may be collectively referred to as audio and video data), and the cloud application client may transmit the video stream and the audio stream to the terminal device. For another example, the cloud application data stream may include object operation data obtained by the terminal device and directed at the cloud application, and the terminal device may transmit the object operation data to the cloud application client running at the server side (that is, the cloud server).

The following describes concepts in one or more aspects of this application:
Cloud application instance: A set of software including a complete cloud application function at a server side (that is, a cloud server) may be referred to as a cloud application instance.
Video memory space: It is an area that is in a video memory at the server side (that is, the cloud server) and that is allocated through a graphics processing unit (GPU) driver to temporarily store a rendered resource corresponding to resource data. In this application, the GPU driver may be collectively referred to as a graphics processing driver component. The graphics processing driver component may include central processing unit (CPU) hardware (referred to as a CPU for short) for providing a data processing service and GPU hardware (referred to as a GPU for short) for providing a resource rendering service. In addition, the graphics processing driver component may further include a driver program at a user layer and a driver program at a kernel layer.

It may be understood that, the resource data in this application may include but is not limited to texture data, vertex data, and shading data. Correspondingly, the rendered resource corresponding to the resource data herein may include but is not limited to a texture resource corresponding to the texture data, a vertex resource corresponding to the vertex data, and a shading resource corresponding to the shading data. In addition, it is to be understood that in this application, resource data that a channel of cloud game client in a cloud server requests to load may be collectively referred to as to-be-rendered resource data. It is to be understood that when the GPU driver does not support a data format of the resource data that the cloud game client requests to load (that is, does not support a data format of the to-be-rendered resource data), the data format of the to-be-rendered resource data needs to be converted in advance through the GPU driver. To-be-rendered resource data after format conversion may be collectively referred to as converted resource data.

The driver program at the user layer and the driver program at the kernel layer may have functions such as invoking the CPU to perform hash search, obtain a global resource address ID based on a global hash value, and obtain a global shared resource based on the global resource address ID. For example, the cloud application client running at the server side (that is, the cloud server) may invoke a corresponding graphics interface provided by the graphics processing driver component (that is, the GPU driver) to load the to-be-rendered resource data, and resource sharing of a rendered resource may be implemented through hash search during loading of the to-be-rendered resource data. It may be understood that the global resource address ID herein may be used for uniquely identifying the global shared resource corresponding to the global hash value found in the global hash table. Based on this, in this application, the global resource address ID may be collectively referred to as a resource ID.

It is to be understood that in this application, a rendered resource currently in a resource sharing state may be collectively referred to as a global shared resource, that is, the global shared resource herein may be a rendered resource in a case that a channel of cloud game client in the cloud server loads, through the GPU driver, to-be-rendered resource data for the first time to output a rendered image. It is to be understood that a storage area corresponding to the global shared resource may be a video memory space allocated in advance in the video memory before the cloud game client requests to load the to-be-rendered resource data that for the first time. An area in which the rendered image (that is, image data that has been rendered) is stored is a frame buffer in the video memory, and the frame buffer may be configured to temporarily store image data that has been rendered by the cloud application client. It may be understood that in one or more aspects of this application, when a plurality of cloud application clients run concurrently in the cloud server, a cloud application client that loads the to-be-rendered resource data for the first time may be collectively referred to as a target cloud application client, that is, the target cloud application client may be one of the plurality of cloud application clients running concurrently.

A direct rendering manager (DRM) is a graphics rendering framework in a Linux system, and may also be referred to as a video card driver framework or a DRM framework. The DRM framework may be configured to drive a video card, to transmit content temporarily stored in the video memory to a display in an appropriate format for display. It is to be understood that in one or more aspects of this application, the video card of the cloud server may not only include graphics storage and transmission functions, but may also include one or more functions of using the GPU driver to perform resource processing, video memory allocation, and/or rendering to obtain 2D/3D graphics.

In the DRM framework, the GPU driver in this application includes the following four modules: a GPU user mode driver, a DRM user mode driver, a DRM kernel mode driver, and a GPU kernel mode driver. The GPU user mode driver and the DRM user mode driver are the driver program at the user layer, and the DRM kernel mode driver and the GPU kernel mode driver are the driver program at the kernel layer.

The GPU user mode driver may be configured to implement a corresponding graphics interface invoked by the cloud server, render a state machine, and manage data.

(2) The DRM user mode driver may be configured to perform interface encapsulation on a kernel operation to be invoked by the graphics interface.

(3) The DRM kernel mode driver may be configured to respond to invocation from the user layer (for example, may respond to invocation from the DRM user mode driver at the user layer), to distribute the invocation to a corresponding driver device (for example, the GPU kernel mode driver).

(4) The GPU kernel mode driver may be configured to respond to driving of the user layer to perform video memory allocation (for example, may allocate a video memory space), manage rendering tasks, drive hardware to operate, and the like.

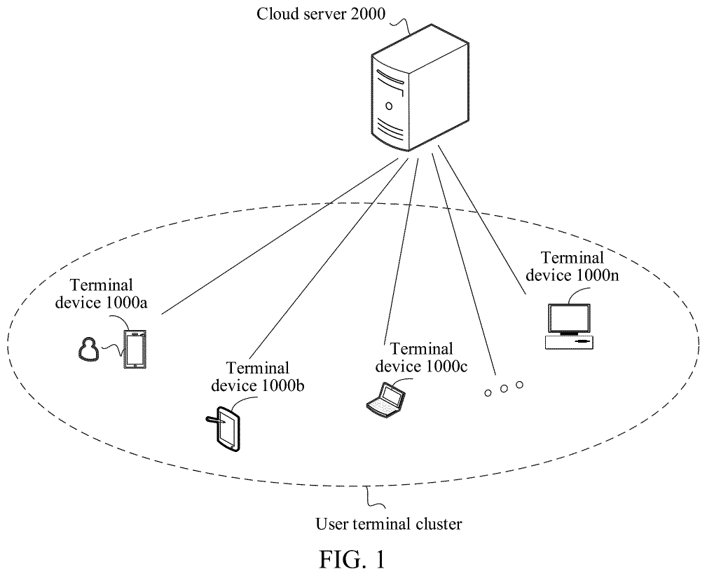

FIG. 1 is a diagram of an architecture of a cloud application processing system according to an aspect of this application. As shown in FIG. 1, the cloud application processing system may include a terminal device 1000a, a terminal device 1000b, a terminal device 1000c, . . . , a terminal device 1000n, and a cloud server 2000. Quantities of terminal devices and cloud servers in the cloud application processing system shown in FIG. 1 are merely examples for description. In a practical application scenario, the quantities of terminal devices and cloud servers in the cloud application processing system may be determined as required. For example, there may be one or more terminal devices and cloud servers. The quantities of terminal devices and cloud servers are not limited in this application.

The cloud server 2000 may run an application program (that is, a cloud application client) of a cloud application. The cloud server 2000 may be an independent server, a server cluster including a plurality of servers, a distributed system, or a server providing basic cloud computing services such as a cloud service, a cloud database, cloud computing, a cloud function, cloud storage, a network service, cloud communication, a middleware service, a domain name service, a security service, a content delivery network (CDN), and/or a big data and artificial intelligence platform. A type of the cloud server 2000 is not limited in this application.

It may be understood that the terminal device 1000a, the terminal device 1000b, the terminal device 1000c, . . . , and the terminal device 1000n shown in FIG. 1 may each include a user client associated with the cloud application client in the cloud server 2000. As shown in FIG. 1, the terminal device 1000a, the terminal device 1000b, the terminal device 1000c, . . . , and the terminal device 1000n may include electronic devices such as a smartphone (for example, an Android mobile phone or an iOS mobile phone), a desktop computer, a tablet computer, a portable personal computer, a mobile Internet device (MID), a wearable device (for example, a smartwatch or a smart band), and an in-vehicle device. Types of the terminal devices in the cloud application processing system are not limited in this application.

As shown in FIG. 1, one or more cloud application clients may run in the cloud server 2000 (one cloud application client herein may be considered as one cloud application instance), and one cloud application client corresponds to one user, that is, one cloud application client may correspond to one terminal device. The one or more cloud application clients running in the cloud server 2000 may run the same cloud application or different cloud applications. For example, when a user A and a user B experience a cloud application 1 at the same time, an instance of the cloud application 1 may be created in the cloud server 2000 for each of the user A and the user B (that is, a first instance of the cloud application 1 may be created in the cloud server 2000 for the user A and a second instance of the cloud application 1 may be created in the cloud server 2000 the user B). When a user A and a user B experience different cloud applications at the same time (for example, the user A experiences a cloud application 1, and the user B experiences a cloud application 2), in the cloud server 2000, an instance of the cloud application 1 may be created for the user A, and an instance of the cloud application 2 may be created for the user B.

The terminal device 1000a, the terminal device 1000b, the terminal device 1000c, . . . , and the terminal device 1000n may all be electronic devices used by players. The players herein may refer to users who are experiencing a cloud application or requesting to experience a cloud application. One terminal device may integrate one or more user clients, each user client may establish a communication connection to a corresponding cloud application client in the cloud server 2000, and the user client and the cloud application client corresponding to the user client may exchange data with each other through the communication connection. For example, a user client in the terminal device 1000a may receive, through a communication connection, audio and video bitstreams transmitted by a cloud application client, to obtain audio and video data of a corresponding cloud application through decoding (for example, image data and audio data when the cloud application client runs a cloud application may be obtained), and output the received audio and video data. Correspondingly, the terminal device 1000a may encapsulate obtained object operation data into an input event data stream and transmit the input event data stream to the corresponding cloud application client, so that when obtaining the object operation data through decapsulation, the cloud application client at the cloud server side may inject the object operation data into the cloud application run by the cloud application client, to execute a corresponding service logic.

It is to be understood that in a cloud application scenario, all cloud application clients run at the cloud server side. To increase a quantity of cloud application instances running concurrently in a single cloud server, it is proposed in aspects of this application that repeated loading of resource data can be advantageously avoided through resource sharing in order to reduce video memory overheads in the cloud server.

It is to be understood that, a cloud application instance herein may be considered as a cloud application client, and one cloud application client corresponds to one user. The cloud application processing system shown in FIG. 1 may be used in a scenario in which cloud applications of a single cloud server run concurrently (which may be understood as that a plurality of cloud application instances run simultaneously in a single cloud server). The plurality of cloud application clients running concurrently in the cloud server 2000 may run in a virtual machine, a container, or other types of virtualized environments provided by the cloud server 2000, and may also run in a non-virtualized environment provided by the server (for example, run directly in a real operating system at the server side), which is not limited in this application. The plurality of cloud application clients running in the cloud server 2000 may share a GPU driver in the cloud server 2000. For example, for the same cloud application, each cloud application client running concurrently may invoke the GPU driver to quickly obtain the same global resource address ID (for example, a resource ID 1) through hash search, and then obtain a global shared resource in a resource sharing state based on the same global resource address ID (for example, the resource ID 1), to implement resource sharing.

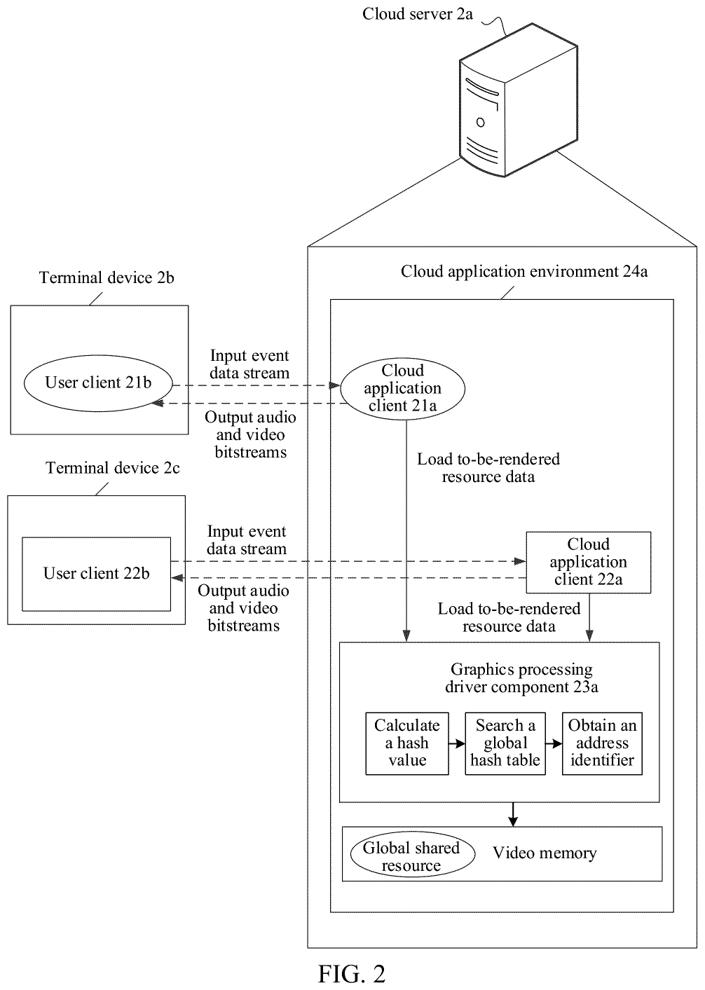

For ease of understanding, a data exchange procedure between the cloud server and the terminal device in the cloud application processing system is described below by using an example that the cloud application is a cloud game. FIG. 2 is a schematic diagram of a data exchange scenario of a cloud application according to an aspect of this application. A cloud server 2a shown in FIG. 2 may be the cloud server 2000 shown in FIG. 1. In the cloud server 2a, a plurality of cloud application clients may run concurrently. The plurality of cloud application clients herein may include a cloud application client 21a and a cloud application client 22a shown in FIG. 2.

When a cloud application concurrently run by the plurality of cloud application clients is a cloud game, the cloud application client 21a herein may be a cloud game client virtualized in a cloud application environment 24a by the cloud server 2a based on a client environment system (for example, an Android system) in which a user client 21b shown in FIG. 2 is located. As shown in FIG. 2, a user client that exchanges data with the cloud application client 21a through a communication connection is the user client 21b. Similarly, the cloud application client 22a may be another cloud game client virtualized in the cloud application environment 24a by the cloud server 2a based on a client environment system (for example, an Android system) in which a user client 22b shown in FIG. 2 is located. Similarly, as shown in FIG. 2, a user client that exchanges data with the cloud application client 22a through a communication connection is the user client 22b.

It is to be understood that the cloud application environment 24a shown in FIG. 2 may be a virtual machine, a container, or other types of virtualized environments that are provided by the cloud server 2a and in which a plurality of cloud application clients can run concurrently. In some aspects, the cloud application environment 24a shown in FIG. 2 may alternatively be a non-virtualized environment (for example, a real operating system of the cloud server 2a) provided by the cloud server 2a. This is not limited.

A terminal device 2b shown in FIG. 2 may be an electronic device used by a user A. The terminal device 2b may integrate one or more user clients associated with different types of cloud games. The user client herein may be understood as a client installed in the terminal device and capable of providing a corresponding cloud game experience service for the user. For example, if the user client 21b in the terminal device 2b is a client associated with a cloud game 1, an icon of the user client 21b in the terminal device 2b may be an icon of the cloud game 1, and the user client 21b may provide an experience service of the cloud game 1 for the user A, that is, the user A may experience the cloud game 1 through the user client 21b in the terminal device 2b.

When the user A wants to experience the cloud game 1, a trigger operation may be performed on the user client 21b in the terminal device 2b. In this case, the terminal device 2b may obtain, in response to the start operation on the user client 21b, a start instruction generated by the user client 21b, and then transmit the start instruction to the cloud server 2a, so that an instance of the cloud game 1 is created or allocated in the cloud server 2a for the user A (that is, the cloud application client 21a corresponding to the cloud game 1 is created or allocated for the user A), and the cloud application client 21a corresponding to the user A runs in the cloud server 2a. At the same time, the user client 21b in the terminal device 2b is also successfully started, that is, the user client 21b in the terminal device 2b and the cloud application client 21a in the server 2a are kept in the same running state.

It is to be understood that if an instance of the cloud game 1 has been deployed in advance in the cloud server 2a, after receiving the start instruction of the user client 21b, the cloud server 2a may directly allocate the instance of the cloud game 1 from the cloud server 2a for the user A, and start the instance of the cloud game 1, which can more quickly start the cloud game 1, thereby reducing a waiting time for the user client 21b to display a page of the cloud game 1. If no instance of the cloud game 1 is deployed in advance in the cloud server 2a, after receiving the start instruction of the user client 21b, the cloud server 2a may create an instance of the cloud game 1 in the cloud server 2a for the user A, and start the newly created instance of the cloud game 1.

Similarly, a terminal device 2c shown in FIG. 2 may be an electronic device used by a user B, and the terminal device 2c may also integrate one or more user clients associated with different types of cloud games. For example, the user client 22b in the terminal device 2c may also be a client associated with the cloud game 1, and an icon of the user client 22b in the terminal device 2c may also be the icon of the cloud game 1. When the user B wants to experience the cloud game 1, a trigger operation may be performed on the user client 22b in the terminal device 2c. In this case, the terminal device 2c may obtain, in response to the start operation on the user client 22b, a start instruction generated by the user client 22b, and then transmit the start instruction to the cloud server 2a, so that an instance of the cloud game 1 is created or allocated in the cloud server 2a for the user B (that is, the cloud application client 22a corresponding to the cloud game 1 is created or allocated for the user B), and the cloud application client 22a corresponding to the user B runs in the cloud server 2a. At the same time, the user client 22b in the terminal device 2c is also successfully started, that is, the user client 22b in the terminal device 2c and the cloud application client 22a in the server 2a are kept in the same running state.

As shown in FIG. 2, when concurrently running the same cloud game (that is, the cloud game 1) in the cloud server 2a, both the cloud application client 21a and the cloud application client 22a may execute a game logic in the cloud game 1. For example, both the cloud application client 21a and the cloud application client 22a may invoke a graphics processing driver component 23a (that is, the GPU driver) shown in FIG. 2 to load to-be-rendered resource data. It is to be understood that in a same-server and same-game (that is, the same cloud game is run in the same cloud server) service scenario, to avoid repeated loading of to-be-rendered resource data of the same cloud game, and as explained below, a service advantage of the cloud game may be fully exerted through resource sharing, to increase a quantity of concurrent channels in the cloud server, thereby reducing operation costs of the cloud game.

As shown in FIG. 2, when the cloud application client 21a obtains to-be-rendered resource data (for example, texture data) of the cloud game 1, hash calculation may be performed through the graphics processing driver component 23a in the cloud application environment 24a, that is, a hash value may be calculated through the graphics processing driver component 23a to obtain a hash value (for example, a hash value H1) of the to-be-rendered resource data (for example, the texture data). The cloud server 2a may further perform a global hash search through the graphics processing driver component 23a, that is, the graphics processing driver component 23a may search a global hash table corresponding to the cloud game 1 to determine whether there is a global hash value identical to the hash value (for example, the hash value H1) of the to-be-rendered resource data (for example, the texture data). If there is a global hash value (for example, a hash value H1′) identical to the hash value (for example, the hash value H1) of the to-be-rendered resource data (for example, the texture data), it may be determined that there is a global resource address ID corresponding to the global hash value (for example, the hash value H1′) in the cloud server 2a. For case of understanding, herein, for example, the global resource address ID is the resource ID 1. The resource ID 1 may be used for uniquely identifying a global shared resource corresponding to the found global hash value (for example, the hash value H1′). Based on this, the graphics processing driver component 23a can quickly obtain, based on the obtained resource ID 1, the global shared resource currently stored and shared in a video memory of the cloud server 2a. Then, the cloud server 2a may map the currently obtained global shared resource to a rendering process corresponding to the cloud game 1, to obtain a rendered image (that is, image data of the cloud game 1) when the cloud game client 21a runs the cloud game 1.

It is to be understood that the global shared resource shown in FIG. 2 may be a rendered resource in a case that the cloud server 2a loads the to-be-rendered resource data for the first time to output the rendered image. For example, for ease of understanding, when the cloud server 2a concurrently runs the cloud application client 22a and the cloud application client 21a, the global shared resource shown in FIG. 2 may be a rendered resource when the cloud application client 22a requests, for the first time through the graphics processing driver component 23a, to load the to-be-rendered resource data to output the rendered image. When it is determined that there is a global shared resource associated with to-be-rendered resource data that the cloud application client 21a currently requests to load in the video memory of the cloud server 2a, the global shared resource can be quickly obtained through resource sharing, so that repeated loading of the to-be-rendered resource data in the cloud server 2a can be advantageously avoided.

It is to be understood that in the same-server and same-game service scenario, both the cloud application client 21a and the cloud application client 22a can share a rendered resource in the same video memory through the GPU driver in the cloud application environment 24a, to advantageously avoid repeated loading of the same resource data. For example, if both the cloud application client 21a and the cloud application client 22a shown in FIG. 2 request to load the same texture data and the same shading data, one video memory space for storing a texture resource corresponding to the texture data and another video memory space for storing a shading resource corresponding to the shading data may be configured in the video memory shown in FIG. 2 through resource sharing for the two cloud application clients (that is, the cloud application client 21a and the cloud application client 22a). Through this resource sharing, it is unnecessary to configure, separately for the cloud application client 21a and the cloud application client 22a, one video memory space for storing the texture resource corresponding to the texture data and another video memory space for storing the shading resource corresponding to the shading data. This precludes separately allocating, in the same video memory for the cloud application clients, video memory spaces for storing the same type and quantity of resources. That is, a global shared resource in the same video memory may be shared through resource sharing, thereby avoiding wasting a video memory resource because video memory spaces of the same size are configured in the same video memory separately for different cloud application clients.

It is to be understood that when the cloud application client 22a stores a rendered resource corresponding to to-be-rendered resource data as a global shared resource into the video memory shown in FIG. 2 for the first time, it is unnecessary to additionally allocate a video memory space of the same size in the video memory for the cloud application client 21a requesting to load the same to-be-rendered resource data, thereby effectively avoiding wasting video memory resources.

The cloud application client 21a and the cloud application client 22a may be considered as sets of software including a complete cloud application function at the server side, which are static. Processes corresponding to the cloud application client 21a and the cloud application client 22a may be established so that the cloud application client 21a and the cloud application client 22a may run in the cloud server 2a, and the processes are dynamic. In other words, when the cloud application client 21a in the cloud server 2a needs to be started, the process corresponding to the cloud application client 21a may be established in the cloud server 2a, and the process in which the cloud application client 21a is located may be started. That is, running the cloud application client 21a in the cloud server 2a is essentially running the process in which the cloud application client 21a is located in the cloud server 2a. The process may be considered as a basic execution entity of the cloud application client 21a in the cloud server 2a. Similarly, when the cloud application client 22a in the cloud server 2a needs to be started, the process corresponding to the cloud application client 22a may be established in the cloud server 2a, and the process in which the cloud application client 22a is located may be started.

It is to be understood that, as shown in FIG. 2, in the cloud application environment 24a in the cloud server 2a, the graphics processing driver component 23a (that is, the GPU driver) shown in FIG. 2 may run, and the GPU driver may provide corresponding graphics interfaces for the cloud application client 21a and the cloud application client 21b running in the cloud server 2a. For example, the process in which the cloud application client 22a is located may invoke a graphics interface provided by the GPU driver to load to-be-rendered resource data (that is, the to-be-rendered resource data shown in FIG. 2) to obtain a rendered image when the cloud application client 22a runs the cloud game 1.

It is to be understood that each frame of rendered image obtained by the cloud application client 22a by invoking the graphics processing driver component 23a may be transmitted to the user client 22b in the terminal device 2c in real time by the cloud application client 22a in a form of audio and video bitstreams obtained through encoding, so that the user client 22b may display each frame of rendered image obtained through decoding. Each piece of operation data obtained by the user client 22b may be transmitted to the cloud application client 22a in a form of an input event data stream, so that the cloud application client 22a injects each piece of operation data obtained through parsing into a cloud application run by the cloud application client 22a (for example, into the cloud game 1 run by the cloud application client 22a). In this way, data is exchanged between the cloud application client 22a in the cloud server 2a and the user client 22b in the terminal device 2c. Similarly, it is to be understood that each rendered image obtained by the cloud application client 21a by invoking the graphics processing driver component 23a may be transmitted in real time by the cloud application client 21a to the user client 21b in the terminal device 2b for display. Each piece of operation data obtained by the user client 21b may be injected into the cloud application client 21a running in the cloud server 2a. In this way, data is exchanged between the cloud application client 21a in the cloud server 2a and the user client 21b in the terminal device 2b.

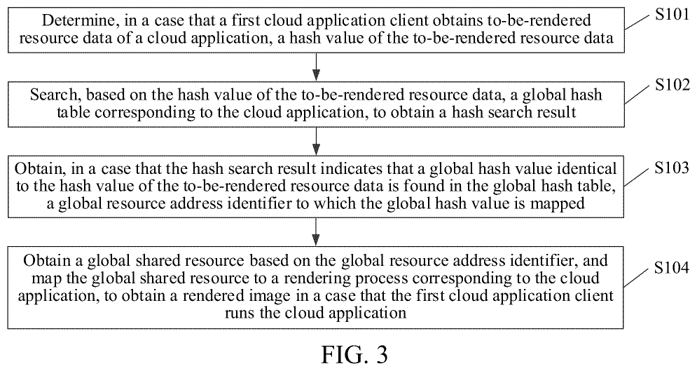

FIG. 3 to FIG. 10 illustrates each cloud application client running concurrently in the cloud server 2a performing a hash calculation, performing a hash search, and obtaining a global shared resource based on a resource ID through the graphics processing driver component 23a.

FIG. 3 is a schematic flowchart of a data processing method according to an aspect of this application. It may be understood that the data processing method may be performed by a cloud server, and the cloud server may be the server 2000 in the cloud application processing system shown in FIG. 1 or the cloud server 2a shown in FIG. 2. The cloud server may include a plurality of cloud application clients running concurrently, and the plurality of cloud application clients herein may include a first cloud application client. In this case, the data processing method may include at least the following steps S101 to S104:

Step S101: Determine, in a case that the first cloud application client obtains to-be-rendered resource data of a cloud application, a hash value of the to-be-rendered resource data.

In some aspects, the cloud server may obtain the to-be-rendered resource data of the cloud application in a case that the first cloud application client runs the cloud application. The cloud server may transmit the to-be-rendered resource data from a magnetic disk of the cloud server to an internal memory space of the cloud server through a graphics processing driver component in a case that the first cloud application client requests to load the to-be-rendered resource data. The cloud server may invoke the graphics processing driver component to determine a hash value of the to-be-rendered resource data in the internal memory space.

The cloud application herein may include but is not limited to the foregoing cloud gaming, cloud education, cloud video streaming, and/or cloud conferencing. For case of understanding, herein, an implementation procedure in which one of the plurality of cloud application clients requests to load to-be-rendered resource data is described by using an example that a cloud application running in the cloud application clients is a cloud game.

For case of understanding, a cloud application client currently requesting to load to-be-rendered resource data in the plurality of cloud application clients running concurrently is referred to as a first cloud application client, and another cloud application client in the plurality of cloud application clients other than the first cloud application client is referred to as a second cloud application client.

Therefore, when the first cloud application client runs the cloud game through a game engine, to-be-rendered resource data of the cloud game can be quickly obtained. The to-be-rendered resource data herein may include but is not limited to the foregoing texture data, vertex data, and shading data. When the first cloud application client requests to load the to-be-rendered resource data, the to-be-rendered resource data may be transmitted from the magnetic disk of the cloud server to an internal memory (that is, the internal memory space) of the cloud server through the graphics processing driver component (that is, the GPU driver), and then the graphics processing driver component may be invoked to quickly determine a hash value of the to-be-rendered resource data stored in the internal memory. Similarly, when the second cloud application client runs the same cloud game through a game engine, the to-be-rendered resource data of the cloud game can also be quickly obtained. When the second cloud application client requests to load the to-be-rendered resource data, the to-be-rendered resource data may also be transmitted from the magnetic disk of the cloud server to the internal memory (that is, the internal memory space) of the cloud server through the graphics processing driver component (for example, the GPU driver), and then the graphics processing driver component may be invoked to quickly determine the hash value of the to-be-rendered resource data stored in the internal memory.

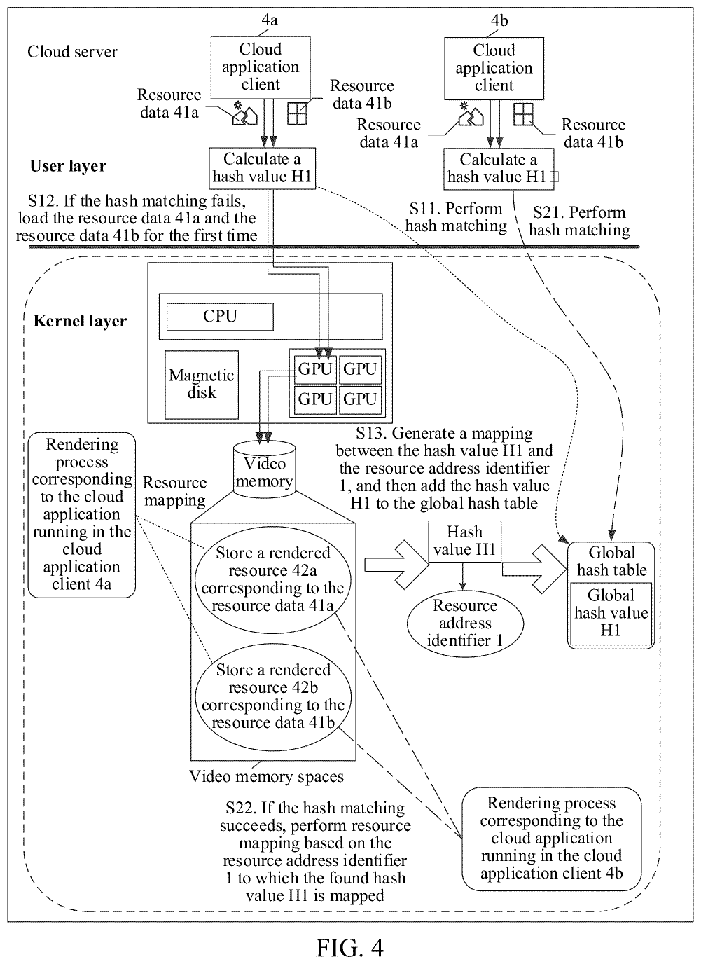

FIG. 4 is a schematic diagram of a scenario of a plurality of cloud application clients running concurrently in a cloud server according to an aspect of this application. A cloud application client 4a shown in FIG. 4 may be the first cloud application client, and a cloud application client 4b shown in FIG. 4 may be the second cloud application client. It is to be understood that when the cloud application is the cloud game 1, the first cloud application client may be a cloud game client (for example, a game client V1) running the cloud game 1, and a user client exchanging data with the cloud game client (for example, the game client V1) may be the user client 21b shown in FIG. 2. This means that the terminal device 2b running the user client 21b may be a game terminal held by the user A. Similarly, the second cloud application client may be a cloud game client (for example, a game client V2) running the cloud game 1, and a user client exchanging data with the cloud game client (for example, the game client V2) may be the user client 22b shown in FIG. 2. This means that the terminal device 2c running the user client 22b may be a game terminal held by the user B.

As shown in FIG. 4, the to-be-rendered resource data that the cloud application client 4a needs to load may be resource data 41a and resource data 41b shown in FIG. 4. When the cloud application is the cloud game 1, the resource data 41a may be texture data, and the resource data 41b may be shading data. For example, the shading data herein may include color data for describing colors of pixels and geometric data for describing a geometric relationship between vertexes. It is to be understood that data types of the resource data 41a and the resource data 41b are not limited herein.

For case of understanding, herein, an implementation procedure in which the cloud application client 4a (that is, the first cloud application client) shown in FIG. 4 loads the resource data 41a and the resource data 41b through a corresponding graphics interface (for example, a glCompressedTexSubImage2D graphics interface for compressing 2D texture resources) is described based on the invocation relationship between the cloud application client 21a and the GPU driver that is described in the aspect corresponding to FIG. 2. It is to be understood that, in this aspect of this application, for case of distinguishing from another graphics interface (for example, a glTexStorage2D graphics interface for storing 2D texture resources) used before the to-be-rendered resource data is loaded, the graphics interface (for example, the glTexStorage2D graphics interface for storing 2D texture resources) used before the to-be-rendered resource data is loaded may be collectively referred to as a first graphics interface, and the graphics interface (for example, the glCompressedTexSubImage2D graphics interface for compressing 2D texture resources) used when the to-be-rendered resource data is loaded may be collectively referred to as a second graphics interface.

When the cloud application client 4a (that is, the first cloud application client) shown in FIG. 4 loads the to-be-rendered resource data (that is, the resource data 41a and the resource data 41b) through the second graphics interface, the to-be-rendered resource data (that is, the resource data 41a and the resource data 41b) may be transmitted from the magnetic disk of the cloud server to the internal memory space of the cloud server through the graphics processing driver component (that is, the GPU driver), to determine a hash value of the to-be-rendered resource data in the internal memory space through the graphics processing driver component (that is, the GPU driver). Similarly, when the cloud application client 4b (that is, the second cloud application client) shown in FIG. 4 loads the to-be-rendered resource data (that is, the resource data 41a and the resource data 41b) through the second graphics interface, the to-be-rendered resource data (that is, the resource data 41a and the resource data 41b) may also be transmitted from the magnetic disk of the cloud server to the internal memory space of the cloud server through the graphics processing driver component (that is, the GPU driver), to determine the hash value of the to-be-rendered resource data in the internal memory space through the graphics processing driver component (that is, the GPU driver).

In some aspects, the cloud application client 4a (that is, the first cloud application client) may transmit, to the graphics processing driver component (that is, the GPU driver), a loading request for loading the to-be-rendered resource data (that is, the resource data 41a and the resource data 41b), so that the graphics processing driver component (that is, the GPU driver) obtains the second graphics interface through parsing, and may invoke CPU hardware in the GPU driver through the second graphics interface to read the resource data 41a and the resource data 41b that are stored in the internal memory space, and then calculate a hash value of the resource data 41a and a hash value of the resource data 41b at a user layer through the CPU hardware in the GPU driver. It is to be understood that in this aspect of this application, the calculated hash value of the resource data 41a and the calculated hash value of the resource data 41b may be collectively referred to as the hash value of the to-be-rendered resource data, and the hash value of the to-be-rendered resource data may be a hash value H1 shown in FIG. 4, so that step S102 may be performed subsequently to deliver the hash value H1 to a kernel layer and search a global hash table at the kernel layer for a global hash value identical to the hash value H1. It is to be understood that the hash value H1 shown in FIG. 4 may include the hash value of the resource data 41a and the hash value of the resource data 41b.

As shown in FIG. 4, the cloud application client 4b (that is, the second cloud application client) may also perform data transmission and hash calculation through the CPU hardware in the GPU driver to calculate a hash value of the to-be-rendered resource data (that is, a hash value of the resource data 41a and a hash value of the resource data 41b). For case of distinguishing, as shown in FIG. 4, the hash value of the to-be-rendered resource data may be a hash value H1′ shown in FIG. 4. Similarly, when the cloud application client 4b (that is, the second cloud application client) calculates the hash value H1′ at the user layer through the GPU driver, the following step S102 may also be performed to transmit the hash value H1′ to the kernel layer to search the global hash table at the kernel layer for a global hash value identical to the hash value H1′.

Step S102: Search, based on the hash value of the to-be-rendered resource data, a global hash table corresponding to the cloud application, to obtain a hash search result.

When the cloud server includes a graphics processing driver component, the graphics processing driver component may include a driver program at a user layer and a driver program at a kernel layer. The hash value of the to-be-rendered resource data may be obtained by the first cloud application client by invoking the graphics processing driver component. The driver program at the user layer may be configured to perform hash calculation on the to-be-rendered resource data stored in the internal memory space of the cloud server. After the cloud server performs step S101, the driver program at the user layer may deliver the hash value of the to-be-rendered resource data to the kernel layer to invoke a driver interface through the driver program at the kernel layer, to search a global hash table corresponding to the cloud application for a global hash value identical to the hash value of the to-be-rendered resource data. If the global hash value identical to the hash value of the to-be-rendered resource data is found in the global hash table, the cloud server may use the result that the global hash value identical to the hash value of the to-be-rendered resource data is found as a search success result. If the global hash value identical to the hash value of the to-be-rendered resource data is not found in the global hash table, the cloud server may use the result that the global hash value identical to the hash value of the to-be-rendered resource data is not found as a search failure result. The cloud server may determine the search success result or the search failure result as the hash search result. In this way, when the hash search result is the search success result, it indicates that the to-be-rendered resource data (for example, texture data) that currently needs to be loaded has been loaded by the target cloud application client for the first time. Therefore, the following steps S103 and S104 may be performed to implement resource sharing. On the contrary, when the hash search result is the search failure result, it indicates that the to-be-rendered resource data (for example, texture data) that currently needs to be loaded has not been loaded by any one of the cloud application clients, and is texture data to be loaded for the first time, and then the graphics processing driver component may be invoked to perform a corresponding texture data loading procedure.

It may be understood that the target cloud application client herein may be the cloud application client 4a (that is, the first cloud application client) shown in FIG. 4, that is, the to-be-rendered resource data (for example, the texture data) may have been loaded for the first time by the first cloud application client itself. For example, when the cloud application client 4a runs the cloud game 1, a rendered resource when the cloud application client 4a loads the to-be-rendered resource data (for example, the texture data) for the first time to output a rendered image may be used as a global shared resource. In this way, when the cloud application client 4a needs to load the to-be-rendered resource data (for example, the texture data) for another time when running the cloud game 1, the global hash value identical to the hash value of the to-be-rendered resource data (for example, the texture data) can be quickly found through hash search.

The target cloud application client herein may alternatively be the cloud application client 4b (that is, the second cloud application client) shown in FIG. 4, that is, the to-be-rendered resource data (for example, the texture data) may alternatively be loaded for the first time by the second cloud application client running concurrently. For example, when the cloud application client 4b concurrently runs the same cloud game (that is, the cloud game 1), a rendered resource when the cloud application client 4b loads the to-be-rendered resource data (for example, the texture data) for the first time to output a rendered image may be used as a global shared resource. In this way, when the cloud application client 4a needs to load the to-be-rendered resource data (for example, the texture data) when running the cloud game 1, the global hash value identical to the hash value of the to-be-rendered resource data (for example, the texture data) can be quickly found directly through hash search. Based on this, the cloud application client that loads the to-be-rendered resource data for the first time is not limited herein.

It is to be understood one cloud application may correspond to one global hash table. In this way, for a plurality of cloud game clients concurrently running the same cloud game, based on the hash value obtained in step S101, whether there is a global hash value identical to a hash value of current to-be-rendered resource data can be quickly determined in a corresponding global hash table.

Referring to FIG. 4, when the graphics processing driver component (that is, the GPU driver) calculates the hash value (for example, the hash value H1 shown in FIG. 4) of the to-be-rendered resource data at the user layer by invoking the CPU hardware, the hash value HI may be delivered to the kernel layer to perform step S101 shown in FIG. 4 at the kernel layer based on the global hash table corresponding to the current cloud application (that is, the cloud game 1), that is, hash matching may be performed at the kernel layer based on the global hash table corresponding to the current cloud application (that is, the cloud game 1), to determine whether there is a global hash value identical to the hash value H1 in the global hash table.

The global hash table shown in FIG. 4 may be a global binary tree constructed with hash values of various rendered resource data (that is, hash values of various to-be-rendered resource data that has been loaded by the cloud server for the first time) as nodes. Each hash value that currently has been written into the global hash table at the kernel layer may be collectively referred to as a global hash value, to search the global hash table to determine whether there is a global hash value identical to the hash value (that is, the hash value H1 shown in FIG. 4 that is calculated at the user layer) of the to-be-rendered resource data. It is to be understood that the rendered resource data herein is used for representing to-be-rendered resource data that has been loaded for the first time.

As shown in FIG. 4, when the cloud application client 4a invokes the graphics processing driver component to load the to-be-rendered resource data (that is, the resource data 41a and the resource data 41b shown in FIG. 4) for the first time, the global hash value matching the hash value of the to-be-rendered resource data is not found in the global hash table, and the hash search failure result occurs. In this case, the cloud server running the cloud application client 4a may perform step S102 shown in FIG. 4 based on the hash search failure result, that is, when the hash matching fails, the cloud server may load the resource data 41a and the resource data 41b as the to-be-rendered resource data for the first time through the GPU driver. For example, as shown in FIG. 4, the resource data 41a and the resource data 41b that are used for calculating the hash value H1 may be transmitted through a direct memory access (DMA) unit (which may also be referred to as a transmission control component) to a video memory shown in FIG. 4, and then the video memory may be accessed through the GPU hardware of the GPU driver, to load to-be-rendered resource data in the video memory onto a first resource object (for example, a resource A) created in advance at the kernel layer.

Before the cloud application client 4a (that is, the first cloud application client) requests to load the to-be-rendered resource data, a video memory space is allocated in advance for the to-be-rendered resource data in the video memory of the cloud server through the GPU driver. For example, as shown in FIG. 4, the cloud server may allocate in advance one video memory space for the resource data 41a and another video memory space for the resource data 41b. Both the video memory space allocated in advance by the cloud server for the resource data 41a and the another video memory space allocated in advance by the cloud server for the resource data 41b may be target video memory spaces allocated by the cloud server for to-be-rendered resource data.

Herein, the target video memory space (that is, the two video memory spaces shown in FIG. 4) may be configured to store a rendered resource obtained by rendering, through the GPU hardware of the GPU driver, the first resource object (for example, the resource A) loaded with the to-be-rendered resource data, that is, the cloud server may map the first resource object (for example, the resource A) currently loaded with the to-be-rendered resource data to a rendering process corresponding to the cloud game 1, to render, through the rendering process, the first resource object (for example, the resource A) currently loaded with the to-be-rendered resource data, to obtain the rendered resource corresponding to the to-be-rendered resource data.

For example, as shown in FIG. 4, the video memory space allocated in advance for the resource data 41a may be configured to store a rendered resource 42a corresponding to the resource data 41a shown in FIG. 4, and the another video memory space allocated in advance for the resource data 41b may be configured to store a rendered resource 42b corresponding to the resource data 41b. It is to be understood that both the rendered resource 42a and the rendered resource 42b shown in FIG. 4 are rendered resources that can be used for resource sharing. In this case, the cloud server may perform step S103 to use the rendered resource (that is, the rendered resources 42a and 42b shown in FIG. 4) corresponding to the to-be-rendered resource data as the global shared resource.

As shown in FIG. 4, the cloud server may add the hash value (that is, the hash value H1 shown in FIG. 4) of the to-be-rendered resource data as a global hash value to the global hash table shown in FIG. 4. In this case, the hash value (that is, the hash value H1 shown in FIG. 4) of the to-be-rendered resource data may be used as a global hash value H1 shown in FIG. 4 in the global hash table.

As shown in FIG. 4, when performing step S103, the cloud server may further generate, for the global shared resource, a resource address ID for uniquely identifying a physical address of the global shared resource, and then may map the resource address ID to the hash value (that is, the hash value H1 shown in FIG. 4) of the to-be-rendered resource data, and add the mapped hash value (that is, the hash value H1 shown in FIG. 4) of the to-be-rendered resource data to the global hash table shown in FIG. 4 for update to obtain the global hash table including the global hash value H1.

As shown in FIG. 4, because the global hash value identical to the hash value (that is, the hash value H1 shown in FIG. 4 that is calculated at the user layer) of the current to-be-rendered resource data is in the global hash table corresponding to the cloud game 1, the following step S103 may be performed to implement video memory resource sharing of the same cloud application client in the same-server and same-game scenario.

Similarly, as shown in FIG. 4, for the cloud application client 4b running concurrently with the cloud application client 4a in the cloud server, when the cloud application client 4b requests to load the same to-be-rendered resource data (for example, the resource data 41a and the resource data 41b shown in FIG. 4), step S102 may be performed based on the calculated hash value (for example, the hash value H1′ shown in FIG. 4) to perform hash matching, and when the hash matching succeeds, the following step S103 may be performed to implement video memory resource sharing between different cloud application clients in the same-server and same-game scenario.

The driver program at the user layer may include a first user mode driver program and a second user mode driver program, and the driver program at the kernel layer may include a first kernel mode driver program and a second kernel mode driver program. When the cloud server performs hash matching through these driver programs in the GPU driver, the hash value (for example, the hash value H1) calculated at the user layer may be delivered layer by layer to the kernel layer based on a program invocation relationship between these driver programs. In this way, when the second kernel mode driver program at the kernel layer obtains the hash value (for example, the hash value H1), the global hash table may be obtained at the kernel layer through the second kernel mode driver program based on a driver interface that is indicated by an input/output (I/O) operation (that is, an I/O operation type) and that is configured to perform hash search, to quickly determine, by searching the global hash table, whether there is a global resource address ID to which a global hash value identical to the current hash value is mapped. This means that the cloud server may determine, in the global hash table through hash matching performed by the second kernel mode driver program in the GPU driver, whether there is a global hash value identical to the current hash value.

Based on this, an implementation procedure in which when the driver program at the user layer delivers the hash value of the to-be-rendered resource data to the kernel layer, the driver interface may be invoked through the driver program at the kernel layer, to search the global hash table corresponding to the cloud application for the global hash value identical to the hash value of the to-be-rendered resource data may be described as follows: In the cloud server, the first user mode driver program may generate, based on the hash value (for example, the hash value H1) calculated at the user layer, a global resource address ID obtaining instruction to be transmitted to the second user mode driver program. When the second user mode driver program receives the global resource address ID obtaining instruction transmitted by the first user mode driver program, the global resource address ID obtaining instruction may be parsed to obtain the hash value (for example, the hash value H1) calculated at the user layer, and then a global resource address ID search command to be transmitted to the first kernel mode driver program at the kernel layer may be generated at the user layer based on the hash value (that is, the hash value H1) obtained through parsing. In this way, when the first kernel mode driver program at the kernel layer receives the global resource address ID search command transmitted by the second user mode driver program at the user layer, a corresponding I/O operation type (for example, an I/O operation type corresponding to the user mode driver program) may be added based on the global resource address ID search command, and then a search driver interface invocation instruction to be distributed to the second kernel mode driver program may be generated at the kernel layer. When the second kernel mode driver program receives the search driver interface invocation instruction transmitted by the first kernel mode driver program, a hash search driver interface (the hash search driver interface herein may be collectively referred to as a driver interface) may be determined based on the I/O operation type (for example, the I/O operation type corresponding to the user mode driver program) added to the search driver interface invocation instruction, and then the determined hash search driver interface may be invoked to search the global hash table for the global hash value identical to the current hash value (for example, the hash value H1).

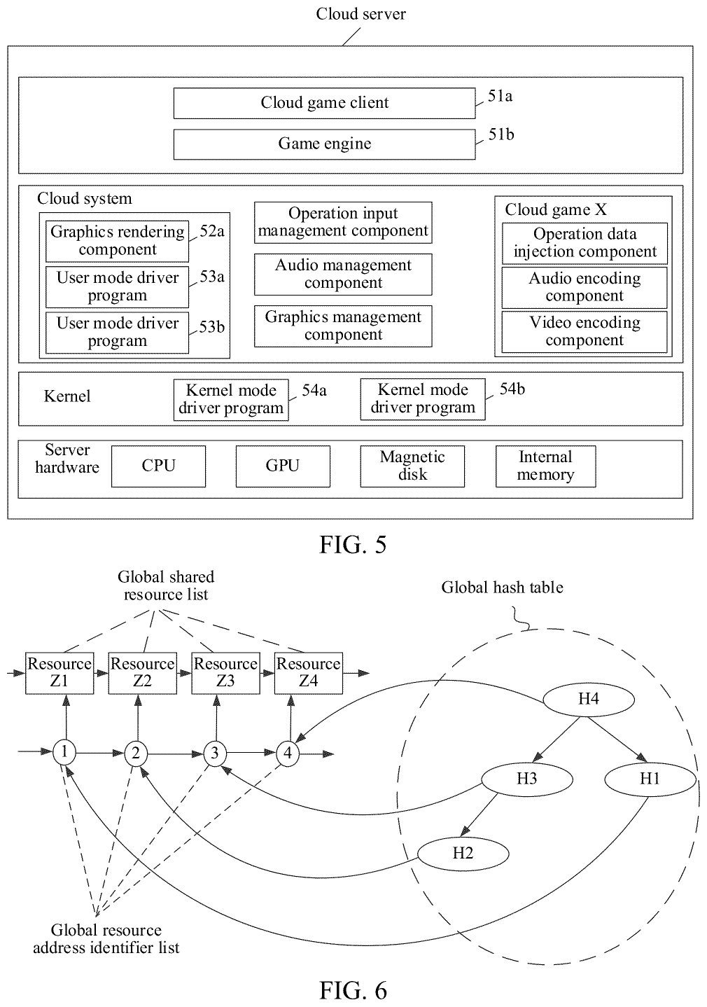

FIG. 5 is a diagram of an internal architecture of a GPU driver deployed in a cloud server according to an aspect of this application. The GPU driver may include a user mode driver program 53a, a user mode driver program 53b, a kernel mode driver program 54a, and a kernel mode driver program 54b shown in FIG. 5. The user mode driver program 53a shown in FIG. 5 is the first user mode driver program at the user layer, and the user mode driver program 53b shown in FIG. 5 is the second user mode driver program at the user layer. Similarly, the kernel mode driver program 54a shown in FIG. 5 is the first kernel mode driver program at the kernel layer, and the kernel mode driver program 54b shown in FIG. 5 is the second kernel mode driver program at the kernel layer.

When the cloud application is a cloud game, a first cloud game client deployed in the cloud server shown in FIG. 5 may be a cloud game client 51a shown in FIG. 5, and the cloud game client 51a may start, through a game engine 51b, a cloud game X shown in FIG. 5, so that the cloud game X can run in the cloud game client 51a.

When the cloud game client 51a runs the cloud game X, to-be-rendered resource data of the cloud game X may be obtained. For case of understanding, herein, an implementation procedure of performing, through an invocation relationship between the four driver programs in the GPU driver, hash search for the hash value delivered from the user layer to the kernel layer may be described by using an example that the to-be-rendered resource data is texture data.

The invocation relationship means that the first user mode driver program may be configured to invoke the second user mode driver program, the second user mode driver program may be configured to invoke the first kernel mode driver program, the first kernel mode driver program may be configured to invoke the second kernel mode driver program, and the second kernel mode driver program invokes a corresponding driver interface to perform a corresponding service operation. For example, the service operation herein may include: configuring a target video memory space for the to-be-rendered resource data, or searching for a resource ID based on the hash value.

When the cloud game client 51a requests the GPU driver to load the texture data, a loading request for loading the texture data may be transmitted to the user mode driver program 53a (that is, the first user mode driver program) shown in FIG. 5, so that when receiving the loading request for the texture data, the user mode driver program 53a (that is, the first user mode driver program) may parse the loading request to obtain the second graphics interface, and then a CPU shown in FIG. 5 may be invoked through the second graphics interface to read the to-be-rendered resource data currently transmitted to an internal memory (that is, an internal memory space), so as to calculate a hash value of the to-be-rendered resource data. The first user mode driver program 53a may generate, based on the hash value (for example, the hash value H1) calculated at the user layer, a global resource address ID obtaining instruction to be transmitted to the user mode driver program 53b. It may be understood that when the user mode driver program 53b receives the global resource address ID obtaining instruction transmitted by the user mode driver program 53a, the global resource address ID obtaining instruction may be parsed to obtain the hash value (for example, the hash value H1) calculated at the user layer, and then a global resource address ID search command to be transmitted to the kernel mode driver program 54a at the kernel layer may be generated at the user layer based on the hash value (that is, the hash value H1) obtained through parsing. In this way, when the kernel mode driver program 54a at the kernel layer receives the global resource address ID search command transmitted by the user mode driver program 53b at the user layer, a corresponding I/O operation type (for example, an I/O operation type corresponding to the user mode driver program 53b) may be added based on the global resource address ID search command, and then a search driver interface invocation instruction to be distributed to the kernel mode driver program 54b may be generated at the kernel layer. When the kernel mode driver program 54b receives the search driver interface invocation instruction transmitted by the kernel mode driver program 54a, a hash search driver interface (the hash search driver interface herein may be collectively referred to as a driver interface) may be determined based on the I/O operation type added to the search driver interface invocation instruction, and then the determined hash search driver interface may be invoked to search the global hash table for a global hash value identical to the current hash value (for example, the hash value H1). When the global hash value identical to the current hash value (for example, the hash value H1) is found, the following step S103 may be performed. The hash value H1 is obtained by the user mode driver program 53a at the user layer by invoking the CPU to read the to-be-rendered resource data (for example, the texture data) in the internal memory space (that is, the internal memory shown in FIG. 5) and perform hash calculation. The to-be-rendered resource data in the internal memory space is transmitted from a magnetic disk shown in FIG. 5 by the cloud game client 51a by invoking CPU hardware (referred to as the CPU for short) in the GPU driver.

A graphics rendering component 52a shown in FIG. 5 may be configured to: when a global shared resource associated with the to-be-rendered resource data is obtained, map the global shared resource to a rendering process corresponding to the cloud game X, to invoke, through the rendering process, the GPU hardware (referred to as the GPU for short) shown in FIG. 5 to perform a rendering operation, so as to output a rendered image when the cloud game client 51a runs the cloud game X. Then, the rendered image stored in a frame buffer may be captured through a graphics management component shown in FIG. 5, and video encoding may be performed on the captured rendered image (that is, captured image data) through a video encoding component shown in FIG. 5, to obtain a video stream of the cloud game X. An audio management component shown in FIG. 5 may be configured to capture audio data associated with the rendered image, and then audio encoding may be performed on the captured audio data through an audio encoding component, to obtain an audio stream of the cloud game X. When the cloud server obtains the video stream and the audio stream of the cloud game X, the video stream and the audio stream of the cloud game X may be returned in a form of streaming media to a user client having a communication connection to the cloud game client 51a. In addition, an operation input management component shown in FIG. 5 may be configured to: when an input event data stream transmitted by the user client is received, obtain object operation data in the input event data stream through parsing, and the object operation data obtained through parsing may be injected into the cloud game X through an operation data injection component shown in FIG. 5, so that a next frame of rendered image of the cloud game X may be obtained as required. A cloud system shown in FIG. 5 in which the cloud game client 51a for running the cloud game X is located is a cloud application environment obtained through virtualization by the cloud server for a client environment system of the user client having the communication connection to the cloud game client 51a.

Step S103: Obtain, in a case that the hash search result indicates that a global hash value identical to the hash value of the to-be-rendered resource data is found in the global hash table, a global resource address ID to which the global hash value is mapped.

If the hash search result indicates that the global hash value identical to the hash value of the to-be-rendered resource data is found in the global hash table, the cloud server may determine that the hash search result is a search success result. The cloud server may determine, based on the search success result, that a rendered resource corresponding to the to-be-rendered resource data has been loaded by a target cloud application client in the cloud server. The target cloud application client herein is one of the plurality of cloud application clients running concurrently. For example, the target cloud application client herein may be the cloud application client 4a of FIG. 4. The cloud server may obtain, in a case that the target cloud application client has loaded the rendered resource corresponding to the to-be-rendered resource data, the global resource address ID to which the global hash value is mapped.

It is to be understood that, as shown in FIG. 4, when the global hash value identical to the current hash value (that is, the hash value of the current to-be-rendered resource data) is found in the global hash table, the resource address ID 1 to which the global hash value H1 is mapped can be quickly found based on the mapping relationship between the global hash value and the global resource address ID that is created when the to-be-rendered resource data is loaded for the first time. Then, the following step S104 may be performed based on the found resource address ID 1.

If the target cloud application client has loaded the rendered resource corresponding to the to-be-rendered resource data, the cloud server may determine, through the driver program at the kernel layer, that there is a global resource address ID associated with the to-be-rendered resource data, and obtain, through the driver program at the kernel layer, the global resource address ID that is associated with the to-be-rendered resource data and to which the global hash value is mapped in a global resource address ID list corresponding to the cloud application. The cloud server may return the global resource address ID to the driver program at the user layer, so that the driver program at the user layer notifies the first cloud application client to perform an operation of obtaining a global shared resource based on the global resource address ID in the following step S104. It may be understood that the global resource address ID list herein is stored in a video memory corresponding to a video card, and each global resource address ID added to the global resource address ID list is a resource ID corresponding to a rendered resource currently as a global shared resource. When a resource ID (for example, the resource ID 1) is added to the global resource address ID list, a one-to-one mapping relationship between the resource ID (for example, the resource ID 1) and a global hash value (for example, the global hash value H1) in the global hash table is established. For example, the mapping relationship established based on the currently added resource ID and the global hash value added to the global hash table may be collectively referred to as a directional search relationship. In this way, the cloud server can quickly obtain the resource ID (for example, the resource ID 1) in the global resource address ID list based on the directional search relationship and the global hash value (for example, the global hash value H1) that is found in the global hash table and that matches the current hash value.

Each resource ID included in the global resource address ID list may be collectively referred to as a global resource address ID. The currently obtained global resource address ID (for example, the resource ID 1) may be transmitted layer by layer between the driver programs (that is, the four driver programs) in the GPU driver based on the invocation relationship between the driver programs of the GPU driver. Based on this, when the second kernel mode driver program in the GPU driver obtains the global resource address ID (for example, the resource ID 1) based on the found global hash value, the global resource address ID (for example, the resource ID 1) may be returned to the first user mode driver program, so that the first user mode driver program may trigger invocation of another driver program (for example, the second user mode driver program, the first kernel mode driver program, or the second kernel mode driver program) in the GPU driver based on the global resource address ID (for example, the resource ID 1).

When obtaining the global resource address ID (for example, the resource ID 1), the first user mode driver program may further return, to the first cloud application client (for example, the cloud game client 51a shown in FIG. 5), a notification message indicating that the global resource address ID is successfully found, so that the first cloud application client performs the following step S104 through the GPU driver. When obtaining the global resource address ID (for example, the resource ID 1), the first user mode driver program may return, to the first cloud application client, a notification message indicating that the global resource address ID is successfully found, and synchronously perform the following step S104.

Step S104: Obtain a global shared resource based on the global resource address ID, and map the global shared resource to a rendering process corresponding to the cloud application, to obtain a rendered image in a case that the first cloud application client runs the cloud application, the global shared resource being a rendered resource in a case that the cloud server loads the to-be-rendered resource data for the first time to output a rendered image.

The global shared resource may be understood as a rendered resource (that is, the rendered resource 42a and the rendered resource 42b shown in FIG. 4) currently added to a global shared resource list. Based on this, the cloud server may invoke a rendering state machine through the GPU driver to configure, to a shared state through the rendering state machine, a resource state of the rendered resource currently added to the global shared resource list. Then, the rendered resource in the shared state may be collectively referred to as the global shared resource.

The cloud server may further allocate, in advance in a video memory resource corresponding to the video card of the cloud server, a corresponding physical address to the global shared resource added to the global shared resource list. The physical address of the global shared resource may be used by the GPU hardware in the GPU driver to access the target video memory space. For example, for case of understanding, an example that the physical address of the global shared resource is OFFF is used to describe an implementation procedure of obtaining, by transmitting a resource ID (for example, the resource ID 1) layer by layer between the driver programs of the GPU driver, the global shared resource stored at the physical address OFFF.

When some (for example, the cloud application client 4a shown in FIG. 4) of the plurality of cloud application clients running concurrently in the cloud server need to load the resource data 41a and the resource data 41b for the second time, to avoid repeated loading of the resource data, when determining that there are global hash values identical to the hash values of the resource data 41a and the resource data 41b, the cloud server may indirectly obtain, based on virtual address spaces dynamically allocated by the GPU driver for physical addresses of global shared resources, the global shared resources stored in the global shared resource list.

Based on this, when the rendered resource corresponding to the to-be-rendered resource data has been stored in the video memory of the cloud server, it can be quickly determined through hash search that there surely is the resource ID to which the rendered resource in the shared state is mapped. In this way, for another cloud game client (that is, the second cloud application client) running concurrently in the cloud server, resource object replacement may be implemented by transmitting a resource ID layer by layer between the programs of the GPU driver (for example, the first resource object created at the kernel layer before the to-be-rendered resource data is loaded this time may be replaced with a second resource object newly created at the kernel layer). Then, when the newly created second resource object is mapped at the kernel layer to a global shared resource obtained based on the resource ID, a virtual address space for mapping to a physical address of the global shared resource may be configured for the second resource object, and the physical address to which the virtual address space is mapped may be accessed by invoking the GPU hardware, to obtain the global shared resource stored at the physical address. It can be learned that, the global shared resource to which the resource ID is mapped can be quickly obtained by transmitting the resource ID layer by layer between the driver programs of the GPU driver, and then video memory resource sharing can be implemented while the current cloud application client (for example, the first cloud application client) does not need to load and compile the to-be-rendered resource data for the second time.

FIG. 6 is a schematic diagram of a search relationship between global service data tables stored in a video card software device according to an aspect of this application. A global shared resource list, a global hash table, and a global resource address ID list shown in FIG. 6 are all created by the video card software device corresponding to the video card of the cloud server. That is, in the video memory corresponding to the video card, the global shared resource list, the global hash table, and the global resource address ID list shown in FIG. 6 may be collectively referred to as the global service data tables.

Resources Z1, Z2, Z3, and Z4 included in the global shared resource list are all rendered resources in the shared state, which means that these rendered resources (that is, the resources Z1, Z2, Z3, and Z4) in the global shared resource list are successively added to the rendering process of the cloud game by the cloud server through the GPU driver to output corresponding rendered images. That is, as shown in FIG. 6, in the global shared resource list, an addition timestamp of the resource Z1 is earlier than an addition timestamp of the resource Z2, the addition timestamp of the resource Z2 is earlier than an addition timestamp of the resource Z3, and by analogy, the addition timestamp of the resource Z3 is earlier than an addition timestamp of the resource Z4. This means that in this case, the resource Z4 in the global shared resource list is the latest global shared resource added to the global shared resource list.

For example, for the resource Z1 shown in FIG. 6, the resource Z1 may be considered as a rendered resource when the cloud server loads to-be-rendered resource data (for example, texture data 1) at a moment T1 for the first time to output a corresponding rendered image (for example, image data 1). Similarly, for the resource Z2 shown in FIG. 6, the resource Z2 may be considered as a rendered resource when the cloud server loads another piece of to-be-rendered resource data (for example, texture data 2, where data content of the texture data 2 is different from data content of the texture data 1) at a moment T2 for the first time to output a corresponding rendered image (for example, image data 2). For the resource Z3 shown in FIG. 6, the resource Z3 may be considered as a rendered resource when the cloud server loads still another piece of to-be-rendered resource data (for example, texture data 3, where data content of the texture data 3 is different from the data content of the texture data 1, and is also different from the data content of the texture data 2) at a moment T3 for the first time to output a corresponding rendered image (for example, image data 3). For the resource Z4 shown in FIG. 6, the resource Z4 may be considered as a rendered resource when the cloud server loads still another piece of to-be-rendered resource data (for example, texture data 4, where data content of the texture data 4 is different from the data content of the texture data 1, the data content of the texture data 2, and the data content of the texture data 3) at a moment T4 for the first time to output a corresponding rendered image (for example, image data 4). It is to be understood that the moment T1, the moment T2, the moment T3, and the moment T4 herein are intended to represent obtaining timestamps when the first cloud game client obtains the to-be-rendered resource data.

In other words, when the to-be-rendered resource data is the texture data 1, a texture resource corresponding to the texture data (that is, a rendered resource corresponding to the to-be-rendered resource data) may be the resource Z1 shown in FIG. 6. In this case, a hash value of the texture data 1 written into the global hash table may be a global hash value H1 shown in FIG. 6, and a global resource address ID to which the global hash value H1 is mapped may be a global resource address ID 1 (for example, the resource ID 1) shown in FIG. 6.

Therefore, when a cloud game client (that is, the first cloud application client) requests to load the texture data 1 for the second time, the cloud server can quickly find a corresponding global service data table based on a directional search relationship (that is, a mapping relationship represented by an arrow direction in FIG. 6) between global service data tables shown in FIG. 6. For example, when the cloud server obtains the hash value of the texture data 1 through calculation of the GPU driver, a global hash value matching the hash value of the texture data 1 may be found in the global hash table shown in FIG. 6 based on the hash value of the texture data 1. In this case, the found global hash value matching the hash value of the texture data 1 may be the global hash value H1 shown in FIG. 6. As shown in FIG. 6, the cloud server may quickly locate, in the global resource address ID list shown in FIG. 6 based on a directional search relationship between the global hash table and the global resource address ID list, a resource ID to which the global hash value H1 is mapped. In this case, the resource ID to which the global hash value H1 is mapped may be the global resource address ID 1 (that is, the resource ID 1) shown in FIG. 6. As shown in FIG. 6, the cloud server may quickly locate, in the global shared resource list shown in FIG. 6 based on a directional search relationship between the global resource address ID list and the global shared resource list, a global shared resource to which the global resource address ID 1 (that is, the resource ID 1) is mapped. In this case, the global shared resource to which the global resource address ID 1 (that is, the resource ID 1) is mapped is the resource Z1 shown in FIG. 6. It is to be understood that, as shown in FIG. 6, for directional search relationships between these global service data tables, refer to directions pointed by arrows shown in FIG. 6.

Similarly, when a cloud game client (that is, the first cloud application client) requests to load the texture data 2 for the second time, the cloud server may successively find corresponding global service data based on the directional search relationships indicated by the arrows between the global service data tables shown in FIG. 6. That is, a global hash value that is quickly found in the global hash table through the GPU driver and that matches a hash value of the texture data 2 is a global hash value H2 shown in FIG. 6, a global resource address ID to which the global hash value H2 is mapped is a global resource address ID 2 (that is, a resource ID 2) shown in FIG. 6, and a global shared resource to which the global resource address ID 2 (that is, the resource ID 2) is mapped is the resource Z2 shown in FIG. 6.

When a cloud game client (that is, the first cloud application client) requests to load the texture data 3 for the second time, the cloud server may also successively find corresponding global service data based on the directional search relationships indicated by the arrows between the global service data tables shown in FIG. 6. That is, a global hash value that is quickly found in the global hash table by the cloud server through the GPU driver and that matches a hash value of the texture data 3 is a global hash value H3 shown in FIG. 6, a global resource address ID to which the global hash value H3 is mapped is a global resource address ID 3 (that is, a resource ID 3) shown in FIG. 6, and a global shared resource to which the global resource address ID 3 (that is, the resource ID 3) is mapped is the resource Z3 shown in FIG. 6. Similarly, when a cloud game client (that is, the first cloud application client) requests to load the texture data 4 for the second time, the cloud server may also successively find corresponding global service data based on the directional search relationships indicated by the arrows between the global service data tables shown in FIG. 6. That is, a global hash value that is quickly found in the global hash table by the cloud server through the GPU driver and that matches a hash value of the texture data 4 is a global hash value H4 shown in FIG. 6, a global resource address ID to which the global hash value H4 is mapped is a global resource address ID 4 (that is, a resource ID 4) shown in FIG. 6, and a global shared resource to which the global resource address ID 4 (that is, the resource ID 4) is mapped is the resource Z4 shown in FIG. 6.

After performing step S102, the cloud server may further perform the following step: If the hash search result indicates that the global hash value identical to the hash value of the to-be-rendered resource data is not found in the global hash table, the cloud server may determine that the hash search result is a search failure result, and determine, based on the search failure result, that the rendered resource corresponding to the to-be-rendered resource data has not been loaded by any one of the plurality of cloud application clients. The cloud server may determine, through the driver program at the kernel layer, that there is not a global resource address ID associated with the to-be-rendered resource data, configure a resource address ID to which the hash value of the to-be-rendered resource data is mapped to a null value, and return the resource address ID corresponding to the null value to the driver program at the user layer, so that the driver program at the user layer notifies the first cloud application client to load the to-be-rendered resource data. For an implementation process of loading the to-be-rendered resource data by the first cloud application client, refer to the description of the implementation procedure of loading the to-be-rendered resource data (that is, the resource data 41a and the resource data 41b shown in FIG. 4) for the first time by the cloud application client 4a in FIG. 4.

During loading (that is, loading for the first time) of the to-be-rendered resource data by the first cloud application client, the following step may be further performed: In a case that a data format of the to-be-rendered resource data is detected as a first data format, the cloud server may convert the data format of the to-be-rendered resource data from the first data format to a second data format, and determine the to-be-rendered resource data in the second data format as converted resource data, so that the converted resource data may be transmitted through the transmission control component (that is, the DMA unit) in the cloud server from the internal memory space to the video memory space (that is, the target video memory space) allocated in advance by the cloud server for the to-be-rendered resource data, so as to load the to-be-rendered resource data onto the first resource object in the video memory space (that is, the target video memory space). The first resource object herein is created through the first graphics interface when the target video memory space is allocated in advance.

When the to-be-rendered resource data is texture data, a data format of texture data that is not supported by the GPU driver is a first data format, and the first data format may include but is not limited to texture data formats such as ASTC, ETC1, and ETC2. In addition, a data format of texture data that is supported by the GPU driver is a second data format, and the second data format may include but is not limited to texture data formats such as RGBA and DXT. Based on this, when the GPU driver encounters an unsupported data format of texture data, format conversion may be performed on the texture data in the first data format through the CPU hardware in the GPU driver. A format conversion operation may alternatively be performed through the CPU hardware or the GPU hardware to convert texture data in the first data format (for example, ASTC, ETC1, or ETC2) into texture data in the second data format (for example, RGBA or DXT). When the to-be-rendered resource data is the texture data, the hash value of the to-be-rendered resource data refers to a hash value of the texture data in the first data format that is calculated before the format conversion.

When a cloud application client (for example, the first cloud application client) running in the cloud server needs to load resource data (that is, the to-be-rendered resource data) of the cloud application, for ease of understanding, herein, for example, the to-be-rendered resource data is the texture data of the to-be-rendered texture resource. In this case, when the first cloud application client needs to request to load the texture data of the to-be-rendered texture resource, a hash value of the texture data of the to-be-rendered texture resource first needs to be calculated (that is, the hash value of the to-be-rendered resource data first needs to be calculated). Then, whether there is a global hash value matching the hash value of the texture data can be quickly determined in the global hash table through hash search, and if yes, it may be determined that there surely is a global resource address ID to which the found global hash value is mapped in the video memory of the cloud server. In this case, the cloud server may quickly obtain a global shared resource corresponding to the texture data from the video memory of the cloud server based on the global resource address ID. When the global shared resource corresponding to the texture data is in the video memory, the global resource address ID for mapping to the global shared resource can be accurately located directly based on the found global hash value, thereby avoiding repeated loading of the resource data (that is, the texture data) in the cloud server through resource sharing. In addition, the cloud server may further map the obtained global shared resource to a rendering process corresponding to the cloud application, to quickly and stably generate, without separately loading and compiling the to-be-rendered resource data (for example, the texture data), a rendered image of the cloud application running in the first cloud application client.

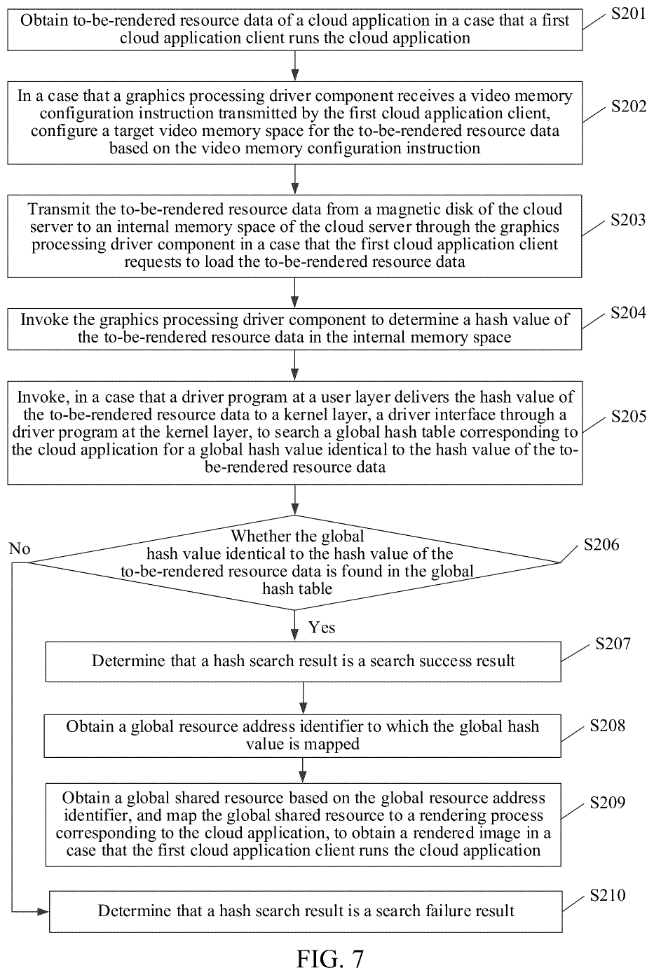

FIG. 7 shows another data processing method according to one or more aspects of this application. The data processing method may performed by a cloud server, and the cloud server may be the server 2000 in the cloud application processing system shown in FIG. 1 or the cloud server 2a shown in FIG. 2. The cloud server may include a plurality of cloud application clients running concurrently, and the plurality of cloud application clients herein may include a first cloud application client and a graphics processing driver component. In this case, the data processing method may include at least the following steps S201 to S210:

Step S201: Obtain to-be-rendered resource data of a cloud application in a case that the first cloud application client runs the cloud application.

For ease of understanding, herein, for example, the cloud application is a cloud game in a cloud game service scenario. In the cloud game service scenario, cloud game clients running the cloud game may be collectively referred to as cloud application clients, that is, the plurality of cloud application clients running concurrently in the cloud server may be a plurality of cloud game clients. The to-be-rendered resource data herein includes at least one or more types of resource data such as texture data, vertex data, and shading data, and a data type of the to-be-rendered resource data is not limited herein.

When a user experiences the cloud application (for example, the cloud game) through the cloud server, if the cloud server needs to obtain data such as the user's personal registration information, camp match information (that is, object game information), game progress information, and to-be-rendered resource data in the cloud game, a corresponding prompt interface or pop-up window may be displayed on a terminal device held by the user. The prompt interface or the pop-up window may be configured to prompt the user that the data such as the personal registration information, the camp match information, the game progress information, and the to-be-rendered resource data is currently to be collected. Therefore, a data obtaining related step may start after a confirmation operation of the user in the prompt interface or the pop-up window is obtained; otherwise, the procedure ends.

For case of distinguishing between these cloud game clients running concurrently, one cloud game client currently running the cloud game may be referred to as the first cloud application client, and another cloud game client currently running the cloud game may be referred to as a second cloud application client, to describe an implementation procedure of resource sharing between different cloud application clients (that is, different cloud game clients) when the first cloud application client and the second cloud application client run concurrently in the cloud server.

Before the first cloud application client requests to load the to-be-rendered resource data (for example, the texture data) through the graphics processing driver component, the following step S202 may be performed, that is, a corresponding video memory space may be allocated in advance in a video memory of the cloud server for the to-be-rendered resource data (the video memory space may be the target video memory space, and the target video memory space herein may be configured to store a rendered resource corresponding to the to-be-rendered resource data, for example, a texture resource corresponding to the texture data). When it determined through hash search that there is not a global hash value identical to a hash value of the to-be-rendered resource data in a global hash table, it may be quickly determined that the to-be-rendered resource data (for example, the texture data) is resource data to be loaded for the first time when the first cloud application client runs the cloud game. Then, when the to-be-rendered resource data (for example, the texture data) is loaded for the first time to obtain the rendered resource (for example, the texture resource), a rendered image when the first cloud application client runs the cloud game may be output. The cloud server may add the texture resource corresponding to the texture data as a global shared resource to a global shared resource list through the graphics processing driver component (that is, the GPU driver).

In this way, when another cloud application client (for example, the second cloud application client) running concurrently with the first cloud application client runs the cloud game, the global shared resource to which a global resource address ID is mapped may be quickly obtained through hash search, thereby implementing video memory resource sharing between a plurality of cloud game clients concurrently running the same cloud game in the same cloud server.

The cloud server may separately configure, for each global shared resource in the global shared resource list, a physical address for GPU hardware to access a corresponding video memory space (for example, a physical address of the video memory space shown in FIG. 4 for storing the rendered resource 42a may be the physical address OFFF). In this way, when a plurality of cloud application clients (that is, a plurality of cloud game clients) run concurrently, and these cloud application clients obtain, by invoking the GPU driver, the resource ID to which the global hash value of the resource data 41a (for example, the texture data) is mapped, a virtual address space for mapping to the physical address of the global shared resource may be configured based on the obtained resource ID (for example, when both the first cloud application client and the second cloud application client request to load the resource data 41a (for example, the texture data) shown in FIG. 4 for the second time, a virtual address space allocated for the first cloud application client may be OX1, and a virtual address space allocated for the second cloud application client may be OX2, where both OX1 and OX2 may be mapped to the same physical address, that is, the physical address OFFF). Then, the texture resource as a global shared resource may be quickly obtained based on the physical address to which the virtual address space is mapped, to implement video memory resource sharing.

It is to be understood that in the plurality of cloud game clients concurrently running the same cloud game in the same cloud server, a cloud game client that loads the to-be-rendered resource data (for example, the texture resource) for the first time may be collectively referred to as a target cloud application client. The target cloud application client herein may be the first cloud application client or the second cloud application client, which is not limited herein. In addition, the rendered resource (for example, the texture resource) obtained when the target cloud application client loads the to-be-rendered resource data (for example, the texture data) for the first time may be collectively referred to as the global shared resource, which means that the global shared resource is a rendered resource when the target cloud application client in the cloud server loads the to-be-rendered resource data for the first time to output a rendered image.

Step S202: In a case that the graphics processing driver component receives a video memory configuration instruction transmitted by the first cloud application client, configure a target video memory space for the to-be-rendered resource data based on the video memory configuration instruction.

The graphics processing driver component includes a driver program at a user layer and a driver program at a kernel layer. When the graphics processing driver component receives the video memory configuration instruction transmitted by the first cloud application client, the driver program at the user layer may determine a first graphics interface based on the video memory configuration instruction, create a first user mode object of the to-be-rendered resource data at the user layer through the first graphics interface, and generate, at the user layer, a user mode allocation command to be transmitted to the driver program at the kernel layer. A first resource object of the to-be-rendered resource data at the kernel layer may created based on the user mode allocation command and a target video memory space may be configured for the first resource object in a case that the driver program at the kernel layer receives the user mode allocation command delivered by the driver program at the user layer.

The driver program at the user layer includes a first user mode driver program and a second user mode driver program. In addition, the driver program at the kernel layer includes a first kernel mode driver program and a second kernel mode driver program. It may be understood that the user mode allocation command is transmitted by the second user mode driver program in the driver program at the user layer.

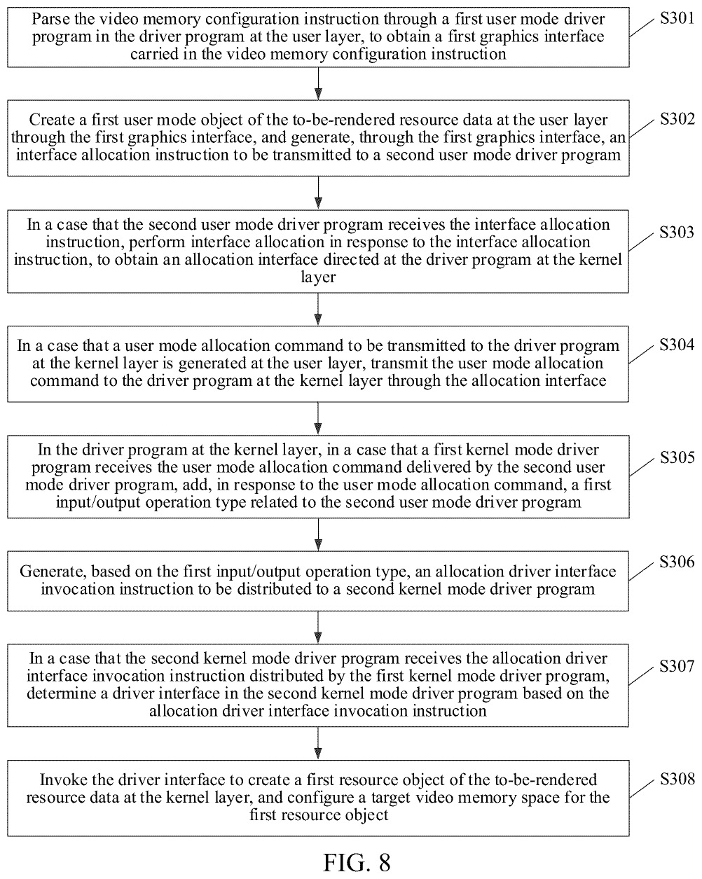

Referring to FIG. 8, a schematic flowchart of allocating a video memory space according to one or more aspects of this application is shown. The schematic flowchart includes at least the following steps S301 to S308:

Step S301: Parse the video memory configuration instruction through the first user mode driver program in the driver program at the user layer, to obtain the first graphics interface carried in the video memory configuration instruction.

Step S302: Create the first user mode object of the to-be-rendered resource data at the user layer through the first graphics interface, and generate, through the first graphics interface, an interface allocation instruction to be transmitted to the second user mode driver program.

Step S303: In a case that the second user mode driver program receives the interface allocation instruction, perform interface allocation in response to the interface allocation instruction, to obtain an allocation interface directed at the driver program at the kernel layer.

Step S304: In a case that the user mode allocation command to be transmitted to the driver program at the kernel layer is generated at the user layer, transmit the user mode allocation command to the driver program at the kernel layer through the allocation interface.

Step S305: In the driver program at the kernel layer, in a case that the first kernel mode driver program receives the user mode allocation command delivered by the second user mode driver program, add, in response to the user mode allocation command, a first I/O operation type related to the second user mode driver program.

Step S306: Generate, based on the first I/O operation type, an allocation driver interface invocation instruction to be distributed to the second kernel mode driver program.

Step S307: In a case that the second kernel mode driver program receives the allocation driver interface invocation instruction distributed by the first kernel mode driver program, determine a driver interface in the second kernel mode driver program based on the allocation driver interface invocation instruction.

Step S308: Invoke the driver interface to create the first resource object of the to-be-rendered resource data at the kernel layer, and configure the target video memory space for the first resource object.

When performing step S308, the cloud server may further configure a resource count value of the first resource object to a first value. For example, the first value may be a value 1. The value 1 herein may be used for indicating that the first resource object created at the kernel layer is currently occupied by one cloud application client, that is, the first cloud application client. It is to be understood that when the to-be-rendered resource data is loaded for the first time, the first resource object loaded with the to-be-rendered resource data may be rendered to obtain the rendered resource corresponding to the to-be-rendered resource data. The resource count value herein is used for describing a cumulative quantity of cloud application clients participating in resource sharing when the rendered resource (that is, the first resource object after the rendering processing) in a shared state is used as a global shared resource.

The cloud server may perform steps S301 to S308 sequentially based on an invocation relationship between the driver programs in the graphics processing driver component (that is, the GPU driver), to configure a corresponding video memory space in advance in the video memory for the to-be-rendered resource data (for example, the texture data and the shading data) in the first cloud application client before the first cloud application client requests to load the to-be-rendered resource data (for example, the texture data and the shading data). For example, the cloud server may allocate in advance one video memory space for the texture data and another video memory space for the shading data. For case of understanding, the video memory space configured for the to-be-rendered resource data (for example, the texture data and the shading data) may be collectively referred to as the target video memory space.

Referring back to FIG. 7, the data processing method may further include at least the following steps:

Step S203: Transmit the to-be-rendered resource data from a magnetic disk of the cloud server to an internal memory space of the cloud server through the graphics processing driver component in a case that the first cloud application client requests to load the to-be-rendered resource data.

Step S204: Invoke the graphics processing driver component to determine a hash value of the to-be-rendered resource data in the internal memory space.

The implementations of steps S201 to S204, may be similar to the implementation of step S101 as discussed above in reference to FIG. 3.

Step S205: Invoke, in a case that the driver program at the user layer delivers the hash value of the to-be-rendered resource data to the kernel layer, a driver interface through the driver program at the kernel layer, to search a global hash table corresponding to the cloud application for a global hash value identical to the hash value of the to-be-rendered resource data.

Step S206: Determine whether the global hash value identical to the hash value of the to-be-rendered resource data is found in the global hash table.

If the global hash value identical to the hash value of the to-be-rendered resource data is found in the global hash table, steps S207-S209 are performed. If the global hash value identical to the hash value of the to-be-rendered resource data is not found in the global hash table, step S210 is performed.

Step S207: Determine that a hash search result is a search success result.

Step S208: Obtain a global resource address ID to which the global hash value is mapped.

Step S209: Obtain a global shared resource based on the global resource address ID, and map the global shared resource to a rendering process corresponding to the cloud application, to obtain a rendered image in a case that the first cloud application client runs the cloud application.

The global shared resource is a rendered resource in a case that the cloud server loads the to-be-rendered resource data for the first time to output a rendered image.

Step S210: Determine that a hash search result is a search failure result.

Steps S205 to S210 may be implemented similarly to the implementation of steps S102 to S104 as discussed above in reference to FIG. 3 (including, for Step S210, when the hash search result is the search failure result, determining that the to-be-rendered resource data that currently needs to be loaded has not been loaded by any one of the cloud application clients, and is to be loaded for the first time, and then invoking the graphics processing driver component to perform a corresponding resource data loading procedure).

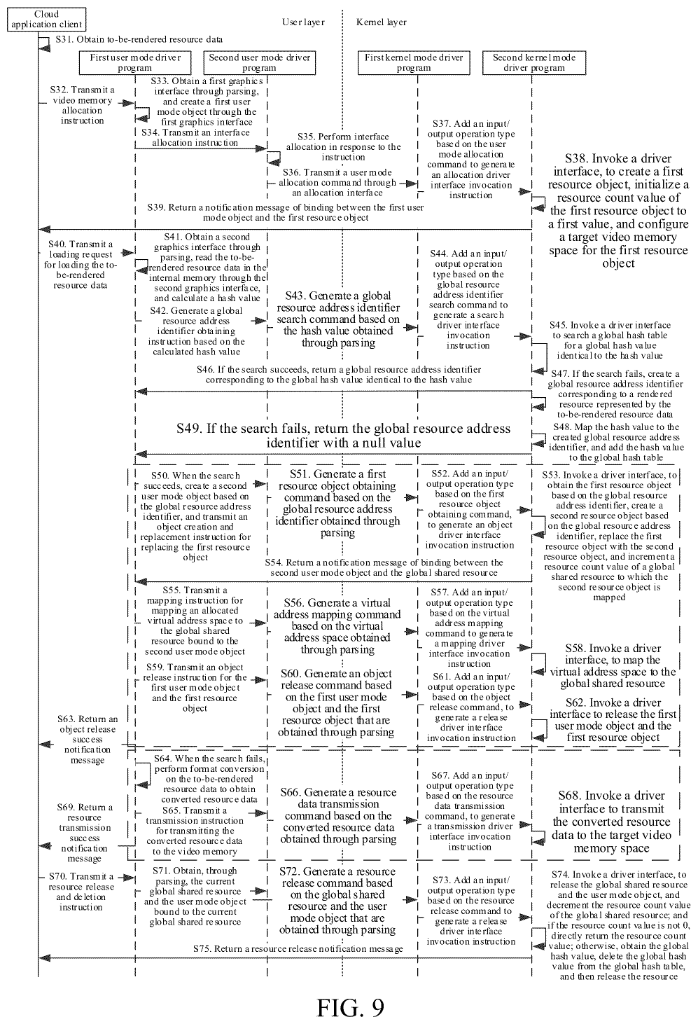

FIG. 9 is an invocation timing diagram for describing an invocation relationship between driver programs in a GPU driver according to one or more aspects of this application. A cloud application client shown in FIG. 9 may be any one of the plurality of cloud application clients running concurrently in the cloud server. The GPU driver in the cloud server may include a first user mode driver program (for example, a GPU user mode driver) and a second user mode driver program (for example, a DRM user mode driver) at a user layer and a first kernel mode driver program (for example, a DRM kernel mode driver) and a second kernel mode driver program (for example, a GPU kernel mode driver) at a kernel layer shown in FIG. 9.

An implementation procedure of loading to-be-rendered resource data in the cloud server is described through the following steps S31 to S72 by using sharing of a 2D compressed texture resource in the cloud server as an example. The to-be-rendered resource data herein may be texture data of the 2D compressed texture resource. When the cloud application client shown in FIG. 9 performs step S31 to obtain to-be-rendered resource data, resource data (that is, texture data) of a to-be-rendered 2D compressed texture resource may be used as the to-be-rendered resource data, to perform step S32 shown in FIG. 9.

In step S32, the cloud application client may transmit a video memory allocation instruction to the first user mode driver program based on a first graphics interface.

In step S33, the first user mode driver program may parse the received video memory allocation instruction to obtain the first graphics interface, and then may create a first user mode object at the user layer through the first graphics interface.

Before the cloud application client loads the texture data, a glTexStorage2D graphics interface may be invoked through the GPU driver to create a corresponding BUF (for example, a BUF A, that is, the first user mode object) at the user layer and a corresponding resource (for example, a resource A, that is, the first resource object) at the kernel layer. When the graphics processing driver component (that is, the GPU driver) receives a video memory configuration instruction transmitted by the first cloud application client (that is, the cloud application client shown in FIG. 9), a target video memory space may be configured for the to-be-rendered resource data based on the video memory configuration instruction.

The glTexStorage2D graphics interface may be referred to as the first graphics interface. The video memory allocation instruction is used for instructing the first user mode driver program in the GPU driver to create the first user mode object (that is, the BUF A) at the user layer through the first graphics interface. When the GPU driver determines the first graphics interface based on the video memory configuration instruction, the first user mode object of the to-be-rendered resource data at the user layer may be created through the first graphics interface, and a user mode allocation command to be transmitted to the driver program at the kernel layer may be generated at the user layer.

In step S34, the first user mode driver program may transmit an interface allocation instruction to the second user mode driver program.

The first user mode driver program may further generate, through the first graphics interface, the interface allocation instruction to be transmitted to the second user mode driver program. The interface allocation instruction herein is used for instructing the second user mode driver program to perform step S35 to perform interface allocation in response to the interface allocation instruction, so that an allocation interface directed at the driver program at the kernel layer shown in FIG. 9 can be obtained.

In step S36, the second user mode driver program may transmit the user mode allocation command to the first kernel mode driver program at the kernel layer through the allocation interface.

The user mode allocation command herein may be understood as an allocation command generated at the user layer to be transmitted to the first kernel mode driver program.

In step S37, when the first kernel mode driver program obtains the user mode allocation command transmitted by the second user mode driver program, a corresponding I/O operation type may be added based on the user mode allocation command to generate an allocation driver interface invocation instruction to be distributed to the second kernel mode driver program.

The first kernel mode driver program (that is, the DRM kernel mode driver) may add, based on the received user mode allocation command, an I/O operation type corresponding to the user mode driver program (that is, a first I/O operation type related to the DRM user mode driver program), and then an I/O operation may be determined based on the added I/O operation type to distribute a processing procedure to a corresponding interface in the GPU kernel mode driver for processing, that is, the first kernel mode driver program may distribute the processing procedure to the second kernel mode driver program based on the determined I/O operation.

In step S38, when the second kernel mode driver program receives the allocation driver interface invocation instruction distributed by the first kernel mode driver program, a driver interface (for example, a video memory allocation driver interface) may be determined in the second kernel mode driver program, to invoke the driver interface (for example, the video memory allocation driver interface) to create a first resource object, and a resource count value of the first resource object may be initialized to a first value. In addition, the second kernel mode driver program may further configure a target video memory space for the first resource object.

In step S39, the first kernel mode driver program may bind the first user mode object (that is, the BUF A) and the first resource object (that is, the resource A), and may return a notification message of the binding between the first user mode object (that is, the BUF A) and the first resource object (that is, the resource A) to the cloud application client.

The implementation of steps S32 to S39 shown in FIG. 9 may be similar to the implementation of steps S301 to S308 as discussed above with reference to FIG. 8.

When the cloud application client receives the notification message, returned by the second kernel mode driver program, of the binding between the first user mode object (that is, the BUF A) and the first resource object (that is, the resource A), step S40 shown in FIG. 9 may be performed to transmit, to the first user mode driver program, a loading request for loading the to-be-rendered resource data. In this way, when the first user mode driver program receives the loading request transmitted by the cloud application client, step S41 may be performed to obtain a second graphics interface through parsing, and then the to-be-rendered resource data stored in the internal memory of the cloud server may be read through the second graphics interface, to calculate a hash value of the to-be-rendered resource data.

As shown in FIG. 9, the first user mode driver program may perform step S42 to generate, based on the calculated hash value, a global resource address ID obtaining instruction to be transmitted to the second user mode driver program. In this way, when the second user mode driver program receives the global resource address ID obtaining instruction, step S43 may be performed to deliver the hash value obtained through parsing to the kernel layer through a global resource address ID search command generated at the user layer. This means that the second user mode driver program may transmit the global resource address ID search command to the first kernel mode driver program at the kernel layer, so that the first kernel mode driver program may perform step S44.

In step S44, the first kernel mode driver program may add, based on the global resource address ID search command, an I/O operation type corresponding to the user mode driver program (that is, a second I/O operation type related to the DRM user mode driver program), to generate a search driver interface invocation instruction to be distributed to the second kernel mode driver program.

In step S45, when the second kernel mode driver program receives the search driver interface invocation instruction distributed by the first kernel mode driver program, an I/O operation indicated by the second I/O operation type may be determined, and then a driver interface (for example, a hash search driver interface) may be invoked to search a global hash table for a global hash value identical to the hash value.

In step S46, when the search succeeds, the second kernel mode driver program may return, to the first user mode driver program, a global resource address ID corresponding to the global hash value identical to the hash value.

In step S47, when the search fails, the second kernel mode driver program may determine that the to-be-rendered resource data is resource data to be loaded for the first time, so as to load the resource data to be loaded for the first time, and then when a rendered resource corresponding to the to-be-rendered resource data is obtained, a global resource address ID corresponding to the rendered resource represented by the to-be-rendered resource data may be created (that is, a resource ID for directionally mapping to the 2D compressed texture resource may be created).

In step S48, the second kernel mode driver program may further map the hash value of the to-be-rendered resource data to the resource ID created in step S47, to write the mapped hash value into the global hash table.

After the hash value of the to-be-rendered resource data is written into the global hash table, it indicates that the rendered resource corresponding to the to-be-rendered resource data is currently a global shared resource in a shared state.

The second kernel mode driver program may perform step S49 to return a global resource address ID with a null value (that is, an ID value of the resource ID for directionally mapping to the global shared resource is 0 in this case) to the first user mode driver program. When the search fails, indicating that the hash value of the current to-be-rendered resource data is not in the global hash table, a loading procedure of loading the to-be-rendered resource data needs to be performed, and when the rendered resource of the to-be-rendered resource data is obtained, the rendered resource may be added to a global resource list. Then, a resource ID for mapping to the rendered resource as a global shared resource may be created in a resource ID list (that is, the global resource address ID list), and the hash value of the to-be-rendered resource data may be put into the global hash table. Similarly, when the second kernel mode driver program finds the global resource address ID (that is, the resource ID) based on the hash value, the resource ID may be returned to the first user mode driver program.

As shown in FIG. 9, when the search succeeds, the GPU driver may perform the following steps S50 to S63. Steps S50 to S63 describe how to obtain the global shared resource based on the resource ID in the GPU driver, to implement resource sharing while reducing video memory overheads. In other words, if it is determined in the GPU driver through hash search that there is the resource ID for mapping to the global shared resource, a new BUF (for example, a BUF B) and a new resource (that is, a resource B, where the resource B created herein is used for mapping to a shared resource B′ subsequently obtained based on the resource ID, the shared resource B′ herein stores texture data of a loaded texture resource, and the loaded texture resource is the global shared resource) may be created based on the resource ID, and a GPU virtual address space is allocated for mapping. Then, the previously created BUF and resource and the video memory space are released to finally implement sharing of the loaded texture resource.

In step S50, when the search succeeds, the first user mode driver program may create a second user mode object (for example, a BUF B) based on the global resource address ID, and transmit an object creation and replacement instruction for replacing the first resource object to the second user mode driver program.

In step S51, when receiving the object creation and replacement instruction transmitted by the first user mode driver program, the second user mode driver program may obtain the global resource address ID through parsing, to generate a first resource object obtaining command to be transmitted to the first kernel mode driver program.

In step S52, when obtaining the first resource object obtaining command, the first kernel mode driver program may add an I/O operation type (that is, a third I/O operation type) based on the first resource object obtaining command, to generate an object driver interface invocation instruction to be distributed to the second kernel mode driver program.

In step S53, when receiving the object driver interface invocation instruction distributed by the first kernel mode driver program, the second kernel mode driver program may invoke a driver interface (for example, a resource obtaining driver interface) based on an I/O operation indicated by the third I/O operation type, to obtain the first resource object based on the global resource address ID, create a second resource object based on the global resource address ID, replace the first resource object with the second resource object, and increment a resource count value of the global shared resource to which the second resource object is mapped.

Then, the second kernel mode driver program may perform step S54 to return a notification message of binding between the second user mode object and the global shared resource to the first user mode driver program. Because the global shared resource has a mapping relationship with the current newly created second resource object, the second kernel mode driver program binds the second user mode object and the global shared resource, which is equivalent to binding the second user mode object and the second resource object having a mapping relationship with the global shared resource.

In step S55, the first user mode driver program may transmit, to the second user mode driver program, a mapping instruction for mapping the allocated virtual address space to the global shared resource bound to the second user mode object.

In step S56, when receiving the mapping instruction, the second user mode driver program may generate, based on the virtual address space obtained through parsing, a virtual address mapping command to be transmitted to the first kernel mode driver program.

In step S57, when receiving the virtual address mapping command transmitted by the second user mode driver program, the first kernel mode driver program may add a corresponding I/O operation type (that is, a fourth I/O operation type) based on the virtual address mapping command, to generate a mapping driver interface invocation instruction to be distributed to the second kernel mode driver program.

In step S58, the second kernel mode driver program may invoke a driver interface (for example, a resource mapping driver interface) based on the received mapping driver interface invocation instruction, to map the virtual address space to the global shared resource.

The implementation of steps S55 to S58 may be similar to the implementation procedure of obtaining the global shared resource based on the resource ID discussed above.

To avoid wasting a video memory resource, the first user mode driver program may further perform step S59 to transmit, when the cloud application client implements resource sharing through the GPU driver, an object release instruction for the first user mode object and the first resource object to the second user mode driver program.

In step S60, when receiving the object release instruction, the second user mode driver program may obtain the first user mode object and the first resource object through parsing, to generate an object release command to be delivered to the first kernel mode driver program.

In step S61, when receiving the object release command, the first kernel mode driver program may add a corresponding I/O operation type (that is, a fifth I/O operation type) based on the object release command, to generate a release driver interface invocation instruction to be distributed to the second kernel mode driver program. In this way, when receiving the release driver interface invocation instruction, the second kernel mode driver program may perform step S62 to invoke a driver interface (for example, an object release driver interface) to release the first user mode object and the first resource object. When these driver programs in the GPU driver collaboratively complete the release of the first user mode object and the first resource object, the GPU driver may further perform step S63 to return an object release success notification message to the cloud application client.

When a plurality of cloud application clients run concurrently in the cloud server, and a cloud application client invokes the GPU driver to release a global shared resource on which the cloud application client currently participates in resource sharing, a resource count value of the global shared resource may be decremented (for example, the resource count value may be subtracted by 1). Based on this, when each of the cloud application clients invokes the GPU driver to release a global shared resource on which the cloud application client currently participates in resource sharing, a resource count value of the global shared resource may be subtracted by 1 sequentially in an invocation order of the cloud application clients. Then, when the resource count value of the global shared resource is completely 0, the global shared resource with the resource count value of 0 may be removed from the global resource list, and a resource ID having a mapping relationship with the global shared resource may be released in the global resource address ID list. In addition, a hash value of resource data corresponding to the global shared resource may also be removed from the global hash table to finally complete release of the global shared resource. When the cloud server releases the global shared resource in the video memory, a video memory space occupied by the global shared resource may also be deleted to reduce video memory overheads. After the cloud server completes the release of the global shared resource (for example, the texture resource corresponding to the texture data), when a cloud application client in the cloud server needs to load the texture data next time, the texture data may be loaded according to the implementation procedure of loading the texture data for the first time.

In step S70, the cloud application client may transmit a resource release and deletion instruction to the first user mode driver program. Therefore, when the first user mode driver program receives the resource release and deletion instruction, step S71 may be performed to obtain, through parsing, the current global shared resource and the user mode object (for example, the second user mode object) bound to the current global shared resource. In step S72, when the second user mode driver program receives the global shared resource and the user mode object (for example, the second user mode object) bound to the current global shared resource that are delivered by the first user mode driver program, a resource release command to be transmitted to the first kernel mode driver program may be generated. When performing step S73, the first kernel mode driver program may add a corresponding I/O operation type (that is, a sixth I/O operation type) based on the resource release command, to generate a release driver interface invocation instruction to be delivered to the second kernel mode driver program. Then, when performing step S74, the second kernel mode driver program may invoke a driver interface (a resource release driver interface) to release the current global shared resource (for example, the resource B′) and the user mode object (for example, the BUF B) bound to the current global shared resource, and decrement the resource count value of the global shared resource. If the resource count value is not 0, the resource count value may be directly returned (for example, a current decremented resource count value may be returned to the cloud application client), that is, there is still another cloud application client in resource sharing of the current global shared resource in this case. On the contrary, the global hash value of the global shared resource may be obtained to delete the global hash value from the global hash table, and then the global shared resource is deleted from the global resource list, to release the global shared resource.

When the search fails, the GPU driver may perform steps S64 to S69 shown in FIG. 9 to implement data transmission when the to-be-rendered resource data is loaded for the first time. For example, as shown in FIG. 9, when the search fails, the first user mode driver program may detect a data format of the to-be-rendered resource data, and when detecting that the data format of the to-be-rendered resource data is the first data format, step S64 may be performed to convert the format of the to-be-rendered resource data (that is, the data format of the to-be-rendered resource data may be converted from the first data format to the second data format) to obtain converted resource data (the converted resource data herein is to-be-rendered resource data in the second data format).

When detecting that the data format of the to-be-rendered resource data is the second data format, the first user mode driver program may directly perform steps S65 to S69 to transmit, based on the invocation relationship between the driver programs in the GPU driver, the to-be-rendered resource data in the second data format to a target video memory space accessible to the GPU.

In step S65, the first user mode driver program may transmit, to the second user mode driver program, a transmission instruction for transmitting the converted resource data to the video memory. In this way, when receiving the transmission instruction, the second user mode driver program may perform step S66 to generate, based on the converted resource data obtained through parsing, a resource data transmission command to be transmitted to the first kernel mode driver program.

In step S67, when the first kernel mode driver program receives the resource data transmission command transmitted by the second user mode driver program, a corresponding I/O operation type (that is, a seventh I/O operation type) may be added based on the resource data transmission command, to generate a transmission driver interface invocation instruction to be delivered to the second kernel mode driver program. Then, when performing step S68, the second kernel mode driver program may invoke a driver interface (a resource transmission driver interface) to transmit the converted resource data to the target video memory space. It is to be understood that when these driver programs in the GPU driver collaboratively complete the data transmission of the converted resource data, the GPU driver may further perform step S69 to return a resource transmission success notification message to the cloud application client.

The implementation of steps S64 to S69 may be similar to the implementation procedure of loading the to-be-rendered resource data for the first time, discussed above with reference to FIG. 4.

Because the video card of the cloud server needs to perform corresponding format conversion on to-be-rendered resource data that is not supported by hardware, when a plurality of cloud application clients concurrently run the same cloud game in a non-resource-sharing mode, loading of the to-be-rendered resource data during the game causes excessive performance overheads. For example, for texture data with a resource data volume of 1 kilobyte (KB), if to load the texture data independently, each cloud application client needs to consume a texture loading time of 3 milliseconds (ms). In this case, when texture data with a large resource data volume needs to loaded in the internal memory for a frame of rendered image to be outputted by each cloud application client, a frame rate of a rendered image obtained when each cloud application client runs the cloud game is inevitably affected (for example, if a large volume of repetitive texture data in the cloud server requires format conversion during the game, a significant frame drop or even a stalling phenomenon occurs), thereby affecting user experience of the cloud game.

Resource sharing may be performed as described herein on a texture resource that is in the video memory and that corresponds to texture data loaded by a cloud application client for the first time, to use the texture resource stored in the video memory as the global shared resource. In this way, for a plurality of cloud application clients running concurrently, when the texture data needs to be loaded for the second time, format conversion and data transmission of the texture data that currently needed to be loaded are not required. Thus the texture resource as the global shared resource can be quickly obtained without additional occupation of server hardware or transmission bandwidth. In this way, for these cloud application clients needing to load the texture data for the second time, a texture loading time is 0 ms. When the global shared resource obtained through resource sharing is mapped to a rendering process corresponding to the cloud game, a rendered image can be output quickly, so that stability of a game frame rate can be maintained ultimately, to improve user experience of the cloud game.

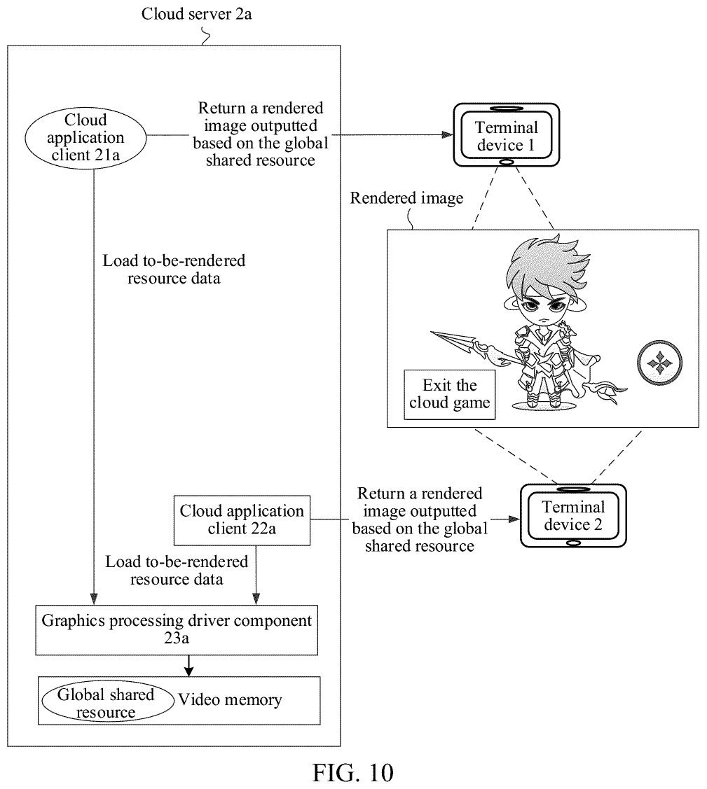

FIG. 10 is a schematic diagram of a scenario of loading to-be-rendered resource data to output a rendered image according to one or more aspects of this application. Both a terminal device 1 and a terminal device 2 shown in FIG. 10 may implement video memory resource sharing through a cloud server 2a. That is, when a user client in the terminal device 1 exchanges data with a cloud application client 21a, to-be-rendered resource data may be loaded through a graphics processing driver component 23a shown in FIG. 10. Similarly, when a user client in the terminal device 2 exchanges data with a cloud application client 22a, to-be-rendered resource data may also be loaded through the graphics processing driver component 23a shown in FIG. 10. As shown in FIG. 10, in a resource sharing mode, both the cloud application client 21a and the cloud application client 22a may obtain a global shared resource in a shared state in a video memory through the graphics processing driver component 23a, and then the obtained global shared resource may be mapped to rendering processes corresponding to respective cloud game clients, to output rendered images when the respective cloud game clients run a cloud game. The rendered images herein may be rendered images displayed on the terminal device 1 and the terminal device 2 shown in FIG. 10. The rendered images displayed on the terminal device 1 and the terminal device 2 may have the same image quality (for example, have a resolution of 1280*720).

In one non-limiting example, in a non-resource-sharing case, both the cloud application client 21a and the cloud application client 22a shown in FIG. 10 may consume 3 ms to load 1K texture data. If much resource data needs to be loaded in an internal memory for this frame, a game frame rate (for example, 30 frames per second) and experience of the cloud game are inevitably negatively affected.

In another example, for the rendered image shown in FIG. 10, if a quantity of channels of game terminals concurrently running the same cloud game is five, video memory overheads used when a cloud application client corresponding to each channel of game terminal loads texture data are about 195 M, and the five channels lead to total video memory overheads of about 2.48 G (the total video memory overheads herein not only include video memory overheads used for loading the texture data, but also include video memory overheads used for loading other resource data, such as vertex data and shading data). Therefore, it is found in practice that, through resource sharing, except that resource data loading of the first channel of terminal device (that is, a game terminal corresponding to a cloud application client requesting to load to-be-rendered resource data for the first time) needs to occupy a video memory of about 195 M, for the other four channels of terminal devices, an allocated video memory for texture data is only 5 M (for example, for the cloud application client 21a and the cloud application client 22a shown in FIG. 10, a video memory of only 5 M is consumed when the texture data is loaded through resource sharing). That is, total video memory overheads of the five channels of terminal devices are about 1.83 G. In this example and compared with the solution before optimization of the technology described herein, this technology can save a video memory space of about 650 M. In a scenario of concurrently running the cloud game with a video memory bottleneck, the saved video memory can be used to concurrently run a new game device, thereby increasing the quantity of concurrent channels of the cloud game.

When a cloud application client (for example, the first cloud application client) running in the cloud server loads resource data (that is, the to-be-rendered resource data, for example, the to-be-rendered resource data may be texture data of a to-be-rendered texture resource) of the cloud application through the GPU driver, the global hash table may be searched based on a hash value of the to-be-rendered resource data (that is, the texture data of the to-be-rendered texture resource), to determine, in the global hash table, whether there is a global hash value identical to the hash value. If yes, it may indirectly indicate that there is a global resource address ID to which the hash value is mapped, and a rendered resource (that is, a global shared resource) shared in the cloud server can be quickly obtained for the first cloud application client based on the global resource address ID. In this way, repeated loading of the resource data can be avoided in the cloud server through resource sharing. On the contrary, if it is determined, in the global hash table, that there is not a global hash value identical to the hash value, it may indirectly indicate that there is not a global resource address ID to which the global hash value is mapped. Then, as there is not a resource ID, the to-be-rendered resource data may be used as resource data to be loaded for the first time, to trigger a loading procedure of the to-be-rendered resource data. The cloud server may further map the obtained rendered resource to the rendering process corresponding to the cloud application, to quickly and stably generate, without separately loading and compiling the to-be-rendered resource data, a rendered image of the cloud application running in the first cloud application client.

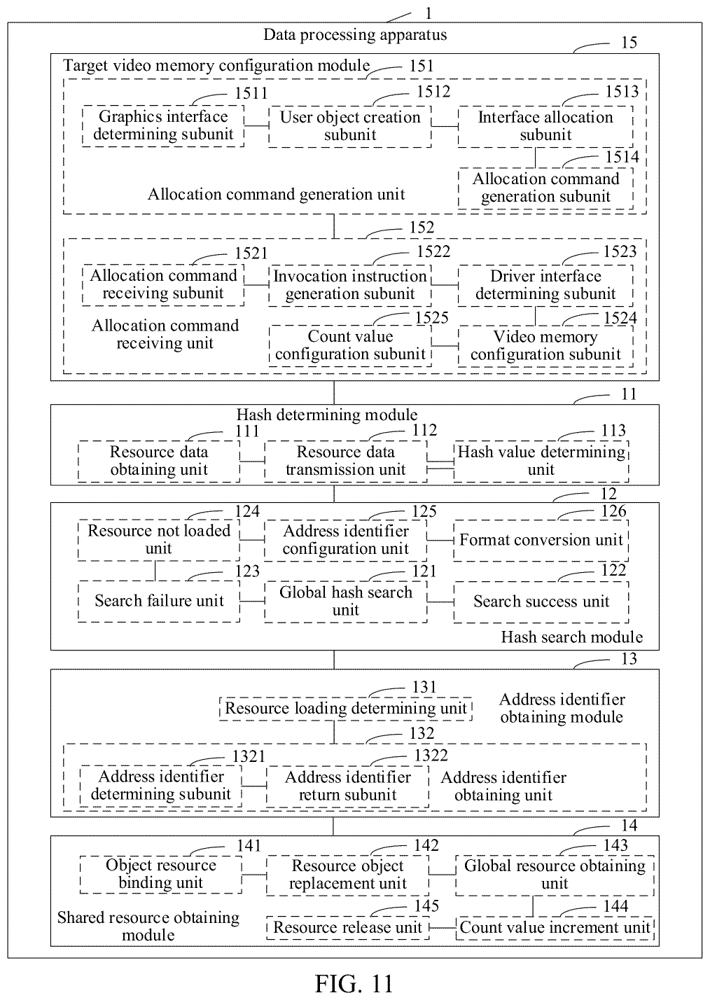

FIG. 11 is a schematic diagram of a structure of a data processing apparatus according to one or more aspects of this application. As shown in FIG. 11, the data processing apparatus 1 may run in a cloud server (for example, the cloud server 2000 of FIG. 1). The data processing apparatus 1 may include a hash determining module 11, a hash search module 12, an address ID obtaining module 13, and a shared resource obtaining module 14.

The hash determining module 11 may be configured to determine, in a case that a first cloud application client obtains to-be-rendered resource data of a cloud application, a hash value of the to-be-rendered resource data. The hash search module 12 may be configured to search, based on the hash value of the to-be-rendered resource data, a global hash table corresponding to the cloud application, to obtain a hash search result. The address ID obtaining module 13 may be configured to obtain, in a case that the hash search result indicates that a global hash value identical to the hash value of the to-be-rendered resource data is found in the global hash table, a global resource address ID to which the global hash value is mapped. The shared resource obtaining module 14 may be configured to obtain a global shared resource based on the global resource address ID, and map the global shared resource to a rendering process corresponding to the cloud application, to obtain a rendered image in a case that the first cloud application client runs the cloud application, the global shared resource being a rendered resource in a case that the cloud server loads the to-be-rendered resource data for the first time.

The implementations of the hash determining module 11, the hash search module 12, the address ID obtaining module 13, and the shared resource obtaining module 14, may be similar to the implementations of steps S101 to S104 as discussed above in reference to FIG. 3.

The cloud server may include a graphics processing driver component, and the hash determining module 11 includes: a resource data obtaining unit 111, a resource data transmission unit 112, and a hash value determining unit 113. The resource data obtaining unit 111 may be configured to obtain the to-be-rendered resource data of the cloud application in a case that the first cloud application client runs the cloud application. The resource data transmission unit 112 may be configured to transmit the to-be-rendered resource data from a magnetic disk of the cloud server to an internal memory space of the cloud server through the graphics processing driver component in a case that the first cloud application client requests to load the to-be-rendered resource data. The hash value determining unit 113 may be configured to invoke the graphics processing driver component to determine a hash value of the to-be-rendered resource data in the internal memory space.

The implementations of the resource data obtaining unit 111, the resource data transmission unit 112, and the hash value determining unit 113 may be similar to the implementations discussed in reference to step S101 of FIG. 3.

The cloud server may include a graphics processing driver component, the graphics processing driver component may include a driver program at a user layer and a driver program at a kernel layer, the hash value of the to-be-rendered resource data may be obtained by the first cloud application client by invoking the graphics processing driver component, and the driver program at the user layer may be configured to perform hash calculation on the to-be-rendered resource data stored in an internal memory space of the cloud server.

The hash search module 12 may include: a global hash search unit 121, a search success unit 122, and a search failure unit 123. The global hash search unit 121 may be configured to invoke, in a case that the driver program at the user layer delivers the hash value of the to-be-rendered resource data to the kernel layer, a driver interface through the driver program at the kernel layer, to search the global hash table corresponding to the cloud application for the global hash value identical to the hash value of the to-be-rendered resource data. The search success unit 122 may be configured to determine that the hash search result is a search success result in a case that the global hash value identical to the hash value of the to-be-rendered resource data is found in the global hash table. The search failure unit 123 may be configured to determine that the hash search result is a search failure result in a case that the global hash value identical to the hash value of the to-be-rendered resource data is not found in the global hash table.

The implementation of the global hash search unit 121, the search success unit 122, the search failure unit 123, may be similar to the implementation discussed in the description of step S102 in FIG. 3.

The address ID obtaining module 13 may include: a resource loading determining unit 131 and an address ID obtaining unit 132. The resource loading determining unit 131 may be configured to determine, in a case that the hash search result is the search success result, that the rendered resource corresponding to the to-be-rendered resource data has been loaded by a target cloud application client in the cloud server, the target cloud application client being one of the plurality of cloud application clients running concurrently. The address ID obtaining unit 132 may be configured to obtain, in a case that the target cloud application client has loaded the rendered resource corresponding to the to-be-rendered resource data, the global resource address ID to which the global hash value is mapped.

The implementation of the resource loading determining unit 131 and the address ID obtaining unit 132 may be similar to the implementation discussed in the description of step S103 in FIG. 3.

The address ID obtaining unit 132 may includes: an address ID determining subunit 1321 and an address ID return subunit 1322. The address ID determining subunit 1321 may be configured to: in a case that the target cloud application client has loaded the rendered resource corresponding to the to-be-rendered resource data, determine, through the driver program at the kernel layer, that there is a global resource address ID associated with the to-be-rendered resource data, and obtain, through the driver program at the kernel layer, the global resource address ID that is associated with the to-be-rendered resource data and to which the global hash value is mapped in a global resource address ID list corresponding to the cloud application. The address ID return subunit 1322 may be configured to return the global resource address ID to the driver program at the user layer, and notify, through the driver program at the user layer, the first cloud application client to perform the operation of obtaining the global shared resource based on the global resource address ID.

The implementation of the address ID determining subunit 1321 and the address ID return subunit 1322, may be similar to the implementation discussed in the description of the implementation procedure of obtaining the global resource address ID in FIG. 3.

The hash search module 12 may further include: a resource not loaded unit 124 and an address ID configuration unit 125. The resource not loaded unit 124 may be configured to: in a case that the hash search result is the search failure result, determine that the rendered resource corresponding to the to-be-rendered resource data has not been loaded by any one of the plurality of cloud application clients. The address ID configuration unit 125 may be configured to: determine, through the driver program at the kernel layer, that there is not a global resource address ID associated with the to-be-rendered resource data, configure a resource address ID to which the hash value of the to-be-rendered resource data is mapped to a null value, and return the resource address ID corresponding to the null value to the driver program at the user layer, so that the driver program at the user layer notifies the first cloud application client to load the to-be-rendered resource data.

The implementation of the resource not loaded unit 124 and the address ID configuration unit 125 may be similar to the implementation procedure of loading the to-be-rendered resource data for the first time discussed with reference to FIG. 3.

During loading of the to-be-rendered resource data by the first cloud application client, the hash search module 12 may further include a format conversion unit 126. The format conversion unit 126 may be configured to: in a case that a data format of the to-be-rendered resource data is a first data format, convert the data format of the to-be-rendered resource data from the first data format to a second data format; determine the to-be-rendered resource data in the second data format as converted resource data; and transmit, through a transmission control component in the cloud server, the converted resource data from the internal memory space to a video memory space allocated in advance by the cloud server for the to-be-rendered resource data.

The implementation of the format conversion unit 126 may be similar to the implementation procedure of converting the data format discussed with reference to FIG. 3.

Before the first cloud application client requests to load the to-be-rendered resource data, the apparatus I may further include a target video memory configuration module 15. The target video memory configuration module 15 may be configured to: in a case that the graphics processing driver component receives a video memory configuration instruction transmitted by the first cloud application client, configure a target video memory space for the to-be-rendered resource data based on the video memory configuration instruction.

The implementation of the target video memory configuration module 15 may be similar to the implementation of step S201 as discussed above with reference to FIG. 7.

The graphics processing driver component may include a driver program at a user layer and a driver program at a kernel layer, and the target video memory configuration module 15 may include: an allocation command generation unit 151 and an allocation command receiving unit 152. The allocation command generation unit 151 may be configured to: determine, through the driver program at the user layer, a first graphics interface based on the video memory configuration instruction, create a first user mode object of the to-be-rendered resource data at the user layer through the first graphics interface, and generate a user mode allocation command at the user layer, the user mode allocation command being transmitted to the driver program at the kernel layer. The allocation command receiving unit 152 may be configured to create a first resource object of the to-be-rendered resource data at the kernel layer based on the user mode allocation command and configure the target video memory space for the first resource object in a case that the driver program at the kernel layer receives the user mode allocation command.

The implementation of the allocation command generation unit 151 and the allocation command receiving unit 152 may be similar to the implementation procedure of configuring the target video memory space discussed in reference to FIG. 7.

The driver program at the user layer may include a first user mode driver program and a second user mode driver program, and the allocation command generation unit 151 may include: a graphics interface determining subunit 1511, a user object creation subunit 1512, an interface allocation subunit 1513, and an allocation command generation subunit 1514. The graphics interface determining subunit 1511 may be configured to parse the video memory configuration instruction through the first user mode driver program in the driver program at the user layer, to obtain the first graphics interface carried in the video memory configuration instruction. The user object creation subunit 1512 may be configured to create the first user mode object of the to-be-rendered resource data at the user layer through the first graphics interface, and generate, through the first graphics interface, an interface allocation instruction to be transmitted to the second user mode driver program. The interface allocation subunit 1513 may be configured to: in a case that the second user mode driver program receives the interface allocation instruction, perform interface allocation in response to the interface allocation instruction, to obtain an allocation interface directed at the driver program at the kernel layer. The allocation command generation subunit 1514 may be configured to: in a case that the user mode allocation command to be transmitted to the driver program at the kernel layer is generated at the user layer, transmit the user mode allocation command to the driver program at the kernel layer through the allocation interface.

The implementations of the graphics interface determining subunit 1511, the user object creation subunit 1512, the interface allocation subunit 1513, and the allocation command generation subunit 1514 may be similar to the implementation procedure of generating the user mode allocation command at the user layer as discussed above in reference to FIG. 7.

The driver program at the kernel layer may include a first kernel mode driver program and a second kernel mode driver program, the user mode allocation command may be transmitted by the second user mode driver program in the driver program at the user layer, and the allocation command receiving unit 152 may include: an allocation command receiving subunit 1521, an invocation instruction generation subunit 1522, a driver interface determining subunit 1523, and a video memory configuration subunit 1524. The allocation command receiving subunit 1521 may be configured to: in the driver program at the kernel layer, in a case that the first kernel mode driver program receives the user mode allocation command delivered by the second user mode driver program, add, in response to the user mode allocation command, a first I/O operation type related to the second user mode driver program. The invocation instruction generation subunit 1522 may be configured to generate, based on the first I/O operation type, an allocation driver interface invocation instruction to be distributed to the second kernel mode driver program. The driver interface determining subunit 1523 may be configured to: in a case that the second kernel mode driver program receives the allocation driver interface invocation instruction, determine a driver interface in the second kernel mode driver program based on the allocation driver interface invocation instruction. The video memory configuration subunit 1524 may be configured to invoke the driver interface to create the first resource object of the to-be-rendered resource data at the kernel layer, and configure the target video memory space for the first resource object.

The implementations of the allocation command receiving subunit 1521, the invocation instruction generation subunit 1522, the driver interface determining subunit 1523, and the video memory configuration subunit 1524 may be similar to the implementation procedure of configuring the target video memory space at the kernel layer as discussed above in reference to FIG. 7.

The allocation command receiving unit 152 may further include a count value configuration subunit 1525. The count value configuration subunit 1525 may be configured to: in a case that the driver interface is invoked to create the first resource object of the to-be-rendered resource data at the kernel layer, configure a resource count value of the first resource object to a first value.

The implementation of the count value configuration subunit 1525 may be similar to the implementation of the resource count value as discussed above in reference to FIG. 7.

The cloud server may include a graphics processing driver component, the graphics processing driver component may be configured to create a first user mode object of the to-be-rendered resource data at a user layer through a first graphics interface before the to-be-rendered resource data may be loaded through a second graphics interface, and the graphics processing driver component may be further configured to create, at a kernel layer, a first resource object bound to the first user mode object. The shared resource obtaining module 14 may include: an object resource binding unit 141, a resource object replacement unit 142, and a global resource obtaining unit 143. The object resource binding unit 141 may be configured to create, through the graphics processing driver component, a second user mode object at the user layer based on the global resource address ID, and create, at the kernel layer, a second resource object bound to the second user mode object. The resource object replacement unit 142 may be configured to: in a case that the graphics processing driver component obtains the first resource object based on the global resource address ID, replace the first resource object with the second resource object. The global resource obtaining unit 143 may be configured to: configure a virtual address space for the second resource object at the kernel layer through the graphics processing driver component, and obtain the global shared resource based on a physical address to which the virtual address space is mapped, the virtual address space being mapped to the physical address of the global shared resource.

The implementations of the object resource binding unit 141, the resource object replacement unit 142, and the global resource obtaining unit 143 may be similar to the implementations discussed in the description of step S104 in as discussed above with reference to FIG. 3.

The shared resource obtaining module 14 may further include: a count value increment unit 144 and a resource release unit 145. The count value increment unit 144 may be configured to: in a case that the global shared resource is obtained based on the global resource address ID, increment a resource count value of the global shared resource through the graphics processing driver component. The resource release unit 145 may be configured to release, through the graphics processing driver component, the first user mode object created at the user layer, the first resource object created at the kernel layer, and a target video memory space configured for the first resource object.

The implementations of the count value increment unit 144 and the resource release unit 145 may be similar to the implementation of the resource release procedure discussed above with reference to FIG. 3.

The data processing apparatus 1 may be integrated and run in the cloud server. In this case, when a cloud application client (for example, the first cloud application client) running in the cloud server needs to load resource data (that is, the to-be-rendered resource data) of the cloud application, the global hash table may be searched based on a hash value of the to-be-rendered resource data, to determine whether there is a global resource address ID to which the hash value is mapped. If yes, a rendered resource (that is, a global shared resource) shared in the cloud server can be quickly obtained for the first cloud application client based on the global resource address ID. In this way, repeated loading of the resource data can be avoided in the cloud server through resource sharing. In addition, it may be understood that, the cloud server may further map the obtained rendered resource to the rendering process corresponding to the cloud application, to quickly and stably generate, without separately loading and compiling the to-be-rendered resource data, a rendered image of the cloud application running in the first cloud application client.

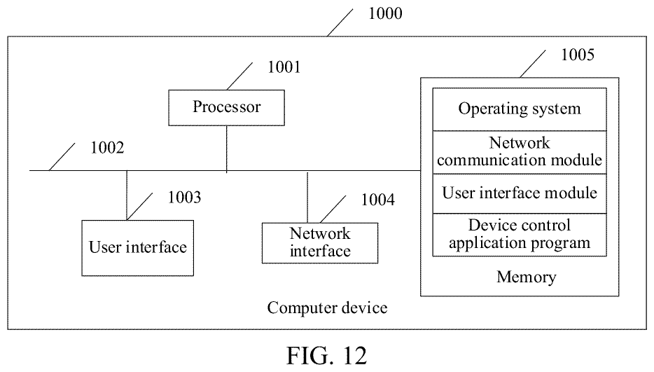

FIG. 12 is a schematic diagram of a structure of a computer device according to one or more aspects of this application. As shown in FIG. 12, the computer device 1000 may be a server. For example, the server herein may be the cloud server 2000 of FIG. 1 or the cloud server 2a of FIG. 2. The computer device 1000 may include: a processor 1001, a network interface 1004, and a memory 1005. In addition, the computer device 1000 may further include: a user interface 1003 and at least one communication bus 1002. The communication bus 1002 may be configured to implement connection and communication between these components. The user interface 1003 may further include a standard wired interface and wireless interface. The network interface 1004 may include a standard wired interface and wireless interface (for example, a Wi-Fi interface). The memory 1005 may be a high-speed random access memory (RAM), or may be a non-volatile memory, for example, at least one magnetic disk storage. Alternatively, the memory 1005 may be at least one storage apparatus located far away from the processor 1001. As shown in FIG. 12, as a computer-readable storage medium, the memory 1005 may include an operating system, a network communication module, a user interface module, and a device control application program.

The network interface 1004 in the computer device 1000 may further provide a network communication function. In the computer device 1000 shown in FIG. 12, the network interface 1004 may provide a network communication function, the user interface 1003 is mainly configured to provide an input interface for a user, and the processor 1001 may be configured to invoke the device control application program stored in the memory 1005, to implement the following operations:
determining, in a case that a first cloud application client obtains to-be-rendered resource data of a cloud application, a hash value of the to-be-rendered resource data;
searching, based on the hash value of the to-be-rendered resource data, a global hash table corresponding to the cloud application, to obtain a hash search result;
obtaining, in a case that the hash search result indicates that a global hash value identical to the hash value of the to-be-rendered resource data is found in the global hash table, a global resource address ID to which the global hash value is mapped; and
obtaining a global shared resource based on the global resource address ID, and mapping the global shared resource to a rendering process corresponding to the cloud application, to obtain a rendered image in a case that the first cloud application client runs the cloud application, the global shared resource being a rendered resource in a case that the cloud server loads the to-be-rendered resource data for the first time to output a rendered image.

The computer device 1000 may perform the data processing method of FIG. 3, and may also perform the data processing method of FIG. 11. The implementation and advantages are similar to those discussed above.

One or more aspects of this application may further provide a computer-readable storage medium. The computer-readable storage medium stores the computer program executed by the data processing apparatus 1, and the computer program includes a computer instruction. When a processor executes the computer instruction, the data processing methods in FIG. 3 and/or FIG. 7 may be performed to achieve the same beneficial effects achieved by using the same method. For technical details that are not disclosed in the computer-readable storage medium aspects of this application, refer to the descriptions of the method aspects of this application. For example, the computer instruction may be deployed on one computing device, a plurality of computing devices at one location, or a plurality of computing devices distributed at a plurality of locations and interconnected through a communication network for execution. The plurality of computing devices distributed at the plurality of locations and interconnected through the communication network may constitute a blockchain system.

In addition, one or more aspects of this application further provide a computer program product or a computer program. The computer program product or the computer program may include a computer instruction, the computer instruction may be stored in a computer-readable storage medium, a processor of a computer device reads the computer instruction from the computer-readable storage medium, and the processor may execute the computer instruction, to cause the computer device to perform the data processing methods of FIG. 3 and/or FIG. 7 to achieve the same beneficial effects achieved by using the same method. For technical details that are not disclosed in the computer program product or computer program aspect of this application, refer to the descriptions of the method aspect of this application.

Persons of ordinary skill in the art may understand that all or a part of the procedures in the foregoing application may be implemented by a computer program instructing relevant hardware. The computer program may be stored in a computer-readable storage medium. When the program runs, the procedures of the foregoing method may be performed. The storage medium may be a magnetic disc, an optical disc, a read-only memory (ROM), or a RAM.

What is disclosed above is merely exemplary aspects of this application, and certainly is not intended to limit the scope of the claims of this application. Therefore, equivalent variations made in accordance with the claims of this application shall fall within the scope of this application.
1-20. (canceled)

1. A method comprising:
determining, by a cloud server and based on a first cloud application client of a plurality of cloud application clients concurrently running on the cloud server requesting to-be-rendered resource data of a cloud application run by the first cloud application client, a hash value of the to-be-rendered resource data;
searching, based on the hash value of the to-be-rendered resource data, a global hash table corresponding to the cloud application, to obtain a hash search result;
obtaining, based on the hash search result indicating that a global hash value identical to the hash value of the to-be-rendered resource data is found in the global hash table, a global resource address identifier to which the global hash value is mapped;
obtaining a global shared resource based on the global resource address identifier; and
mapping the global shared resource to a rendering process corresponding to the cloud application to obtain a rendered image, wherein the global shared resource is a rendered resource if the cloud server loads the to-be-rendered resource data for a first time.

2. The method according to claim 1,
wherein the cloud server comprises a graphics processing driver component; and
wherein the determining comprises:
transmitting the to-be-rendered resource data from a magnetic disk of the cloud server to an internal memory space of the cloud server through the graphics processing driver component; and
invoking the graphics processing driver component to determine a hash value of the to-be-rendered resource data in the internal memory space.

3. The method according to claim 1,
wherein the cloud server comprises a graphics processing driver component that comprises a driver program at a user layer and a driver program at a kernel layer,
wherein the hash value of the to-be-rendered resource data is obtained by the first cloud application client by invoking the graphics processing driver component,
wherein the driver program at the user layer is configured to perform hash calculation on the to-be-rendered resource data stored in an internal memory space of the cloud server; and
wherein the searching comprises:
invoking, based on the driver program at the user layer delivering the hash value of the to-be-rendered resource data to the kernel layer, a driver interface through the driver program at the kernel layer, to search the global hash table corresponding to the cloud application for an identical global hash value;
determining that the hash search result is a search success result based on finding the identical global hash value in the global hash table or a search failure based on not finding an identical global hash value in the global hash table.

4. The method according to claim 3, wherein the obtaining the global resource address identifier comprises:
determining, based on the hash search result indicating a search success result, that the rendered resource corresponding to the to-be-rendered resource data has been loaded by a target cloud application client in the cloud server, the target cloud application client being one of the plurality of cloud application clients running concurrently; and
obtaining the global resource address identifier to which the global hash value is mapped.

5. The method according to claim 4, wherein the obtaining the global resource address identifier comprises:
determining, through the driver program at the kernel layer, that there is a global resource address identifier associated with the to-be-rendered resource data;
obtaining, through the driver program at the kernel layer, the global resource address identifier to which the global hash value is mapped in a global resource address identifier list corresponding to the cloud application;
returning the global resource address identifier to the driver program at the user layer; and
notifying, through the driver program at the user layer, the first cloud application client to obtain the global shared resource based on the global resource address identifier.

6. The method according to claim 3, further comprising:
determining, based on the hash search result indicating a search failure result, that the rendered resource corresponding to the to-be-rendered resource data has not been loaded by any one of the plurality of cloud application clients;
determining, through the driver program at the kernel layer, that there is not a global resource address identifier associated with the to-be-rendered resource data;
configuring a resource address identifier to which the hash value of the to-be-rendered resource data is mapped to a null value;
returning the resource address identifier corresponding to the null value to the driver program at the user layer; and
notifying, through the driver program at the user layer, the first cloud application client to load the to-be-rendered resource data.

7. The method according to claim 6, wherein the method further comprises, during loading of the to-be-rendered resource data by the first cloud application client:
based on determining that a data format of the to-be-rendered resource data is a first data format, converting the data format of the to-be-rendered resource data from the first data format to a second data format;
determining the to-be-rendered resource data in the second data format is a converted resource data; and
transmitting, through a transmission control component in the cloud server, the converted resource data from the internal memory space to a video memory space allocated in advance by the cloud server for the to-be-rendered resource data.

8. The method according to claim 2, wherein the method further comprises, prior to the first cloud application client requesting to load the to-be-rendered resource data:
configuring, based on determining that the graphics processing driver component receives a video memory configuration instruction transmitted by the first cloud application client, a target video memory space for the to-be-rendered resource data based on the video memory configuration instruction.

9. The method according to claim 8,
wherein the graphics processing driver component comprises a driver program at a user layer and a driver program at a kernel layer, and
wherein the configuring a target video memory space for the to-be-rendered resource data based on the video memory configuration instruction comprises:
determining, through the driver program at the user layer, a first graphics interface based on the video memory configuration instruction;
creating a first user mode object of the to-be-rendered resource data at the user layer through the first graphics interface;
generating a user mode allocation command at the user layer;
sending the user mode allocation command to the driver program at the kernel layer;
creating a first resource object of the to-be-rendered resource data at the kernel layer based on the user mode allocation command; and
configuring the target video memory space for the first resource object in a case that the driver program at the kernel layer receives the user mode allocation command.

10. The method according to claim 9,
wherein the driver program at the user layer comprises a first user mode driver program and a second user mode driver program, and
wherein the method further comprises:
parsing the video memory configuration instruction through the first user mode driver program in the driver program at the user layer, to obtain the first graphics interface carried in the video memory configuration instruction;
creating the first user mode object of the to-be-rendered resource data at the user layer through the first graphics interface;
generating, through the first graphics interface, an interface allocation instruction to be transmitted to the second user mode driver program;
performing, based on the second user mode driver program receiving the interface allocation instruction, interface allocation in response to the interface allocation instruction, to obtain an allocation interface directed at the driver program at the kernel layer; and
sending, based on the user mode allocation command being generated at the user layer, the user mode allocation command to the driver program at the kernel layer through the allocation interface.

11. The method according to claim 9, wherein the driver program at the kernel layer comprises a first kernel mode driver program and a second kernel mode driver program, and the user mode allocation command is transmitted by the second user mode driver program in the driver program at the user layer, the method further comprising:
based on the first kernel mode driver program receiving the user mode allocation command delivered by the second user mode driver program, adding, in the driver program at the kernel layer and in response to the user mode allocation command, a first input/output operation type related to the second user mode driver program;
generating, based on the first input/output operation type, an allocation driver interface invocation instruction to be distributed to the second kernel mode driver program;
based on the second kernel mode driver program receiving the allocation driver interface invocation instruction, determining a driver interface in the second kernel mode driver program based on the allocation driver interface invocation instruction;
invoking the driver interface to create the first resource object of the to-be-rendered resource data at the kernel layer; and
configuring the target video memory space for the first resource object.

12. The method according to claim 11, further comprising:
configuring a resource count value of the first resource object to a first value.

13. The method according to claim 1, wherein the cloud server comprises a graphics processing driver component configured to create a first user mode object of the to-be-rendered resource data at a user layer through a first graphics interface before the to-be-rendered resource data is loaded through a second graphics interface, and to create, at a kernel layer, a first resource object bound to the first user mode object, and
wherein the obtaining the global shared resource based on the global resource address identifier comprises:
creating, through the graphics processing driver component, a second user mode object at the user layer based on the global resource address identifier;
creating, at the kernel layer, a second resource object bound to the second user mode object;
based on the graphics processing driver component obtaining the first resource object based on the global resource address identifier, replacing the first resource object with the second resource object;
configuring a virtual address space for the second resource object at the kernel layer through the graphics processing driver component; and
obtaining the global shared resource based on a physical address to which the virtual address space is mapped, the virtual address space being mapped to the physical address of the global shared resource.

14. The method according to claim 13, further comprising:
incrementing a resource count value of the global shared resource through the graphics processing driver component; and
releasing, through the graphics processing driver component, the first user mode object created at the user layer, the first resource object created at the kernel layer, and a target video memory space configured for the first resource object.

15. An apparatus comprising:
one or more processors; and
memory storing instructions that, when executed by the one or more processors, cause the one or more processors to:
determine, based on a first cloud application client of a plurality of cloud application clients concurrently running on a cloud server requesting to-be-rendered resource data of a cloud application run by the first cloud application client, a hash value of the to-be-rendered resource data;
search, based on the hash value of the to-be-rendered resource data, a global hash table corresponding to the cloud application, to obtain a hash search result;
obtain, based on the hash search result indicating that a global hash value identical to the hash value of the to-be-rendered resource data is found in the global hash table, a global resource address identifier to which the global hash value is mapped;
obtain a global shared resource based on the global resource address identifier; and
map the global shared resource to a rendering process corresponding to the cloud application to obtain a rendered image, wherein the global shared resource is a rendered resource if the cloud server loads the to-be-rendered resource data for a first time.

16. The apparatus according to claim 15, wherein the determining comprises:
transmitting the to-be-rendered resource data from a magnetic disk of a cloud server to an internal memory space of the cloud server through the graphics processing driver component; and
invoking the graphics processing driver component to determine a hash value of the to-be-rendered resource data in the internal memory space.

17. The apparatus according to claim 15,
wherein the cloud server comprises a graphics processing driver component that comprises a driver program at a user layer and a driver program at a kernel layer,
wherein the hash value of the to-be-rendered resource data is obtained by the first cloud application client by invoking the graphics processing driver component,
wherein the driver program at the user layer is configured to perform hash calculation on the to-be-rendered resource data stored in an internal memory space of the cloud server; and
wherein the searching comprises:
invoking, based on the driver program at the user layer delivering the hash value of the to-be-rendered resource data to the kernel layer, a driver interface through the driver program at the kernel layer, to search the global hash table corresponding to the cloud application for an identical global hash value;
determining that the hash search result is a search success result based on finding the identical global hash value in the global hash table or a search failure based on not finding an identical global hash value in the global hash table.

18. A system comprising:
a cloud server;
one or more processors; and
memory storing instructions that, when executed by the one or more processors, cause the one or more processors to:
determine, based on a first cloud application client of a plurality of cloud application clients concurrently running on the cloud server requesting to-be-rendered resource data of a cloud application run by the first cloud application client, a hash value of the to-be-rendered resource data;
search, based on the hash value of the to-be-rendered resource data, a global hash table corresponding to the cloud application, to obtain a hash search result;
obtain, based on the hash search result indicating that a global hash value identical to the hash value of the to-be-rendered resource data is found in the global hash table, a global resource address identifier to which the global hash value is mapped;
obtain a global shared resource based on the global resource address identifier; and
map the global shared resource to a rendering process corresponding to the cloud application to obtain a rendered image, wherein the global shared resource is a rendered resource if the cloud server loads the to-be-rendered resource data for a first time.

19. The system according to claim 18, wherein the determining comprises:
transmitting the to-be-rendered resource data from a magnetic disk of a cloud server to an internal memory space of the cloud server through the graphics processing driver component; and
invoking the graphics processing driver component to determine a hash value of the to-be-rendered resource data in the internal memory space.

20. The system according to claim 18,
wherein an associated cloud server comprises a graphics processing driver component that comprises a driver program at a user layer and a driver program at a kernel layer,
wherein the hash value of the to-be-rendered resource data is obtained by the first cloud application client by invoking the graphics processing driver component,
wherein the driver program at the user layer is configured to perform hash calculation on the to-be-rendered resource data stored in an internal memory space of the cloud server; and
wherein the searching comprises:
invoking, based on the driver program at the user layer delivering the hash value of the to-be-rendered resource data to the kernel layer, a driver interface through the driver program at the kernel layer, to search the global hash table corresponding to the cloud application for an identical global hash value; and
determining that the hash search result is a search success result based on finding the identical global hash value in the global hash table or a search failure based on not finding an identical global hash value in the global hash table.
